(19) United States
(12) Patent Application Publication
(10) Pub. No.: US 2021/0096760 A1
(43) Pub. Date: Apr. 1, 2021

(54) APPARATUS AND METHOD FOR TRANSCEIVING OPERATION INFORMATION IN A DATA PROCESSING SYSTEM INCLUDING A MEMORY SYSTEM

(71) Applicant: SK hynix Inc., Gyeonggi-do (KR)

(72) Inventors: Jun Cho, Gyeonggi-do (KR); Jin-Soo Kim, Gyeonggi-do (KR); Soong-Sun Shin, Gyeonggi-do (KR)

(21) Appl. No.: 16/856,123

(22) Filed: Apr. 23, 2020

(30) Foreign Application Priority Data
Oct. 1, 2019 (KR) 10-2019-0121675

(51) Int. Cl. G06F 3/06; G06F 11/07

(52) U.S. Cl. CPC G06F 3/0647; G06F 3/0653; G06F 11/0772; G06F 3/0613; G06F 3/0673; G06F 3/0659

(57) ABSTRACT

A data processing system includes a memory system configured to transfer to, or receive from, a host, a piece of data in an in-band communication way. The memory system is configured to transfer a packet to the host in an out-of-band communication way. The packet includes a first type item, including a parameter regarding an idle status, a data input/output processing status and a status showing a sequential or random write operation in the memory system, and a second type item including a variable corresponding to the parameter.

### CROSS-REFERENCE TO RELATED APPLICATIONS

This patent application claims to the benefit of Korean Patent Application No. 10-2019-0121675, filed on Oct. 1, 2019, the entire disclosure of which is incorporated herein by reference.

### TECHNICAL FIELD

An embodiment of this disclosure relates to a memory system and a data processing system including a host and the memory system, and more particularly, to a method and apparatus for transmitting or receiving operation information between the memory system and the host.

### BACKGROUND

Recently, a paradigm for a computing environment has shifted to ubiquitous computing, which enables computer systems to be accessed virtually anytime and everywhere. As a result, the use of portable electronic devices, such as mobile phones, digital cameras, notebook computers and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a nonvolatile semiconductor memory device is advantageous in that it has excellent stability and durability because it has no mechanical driving part (e.g., a mechanical arm), and has high data access speed and low power consumption. In the context of a memory system having such advantages, an exemplary data storage device includes a USB (Universal Serial Bus) memory device, a memory card having various interfaces, a solid state drive (SSD) or the like.

### BRIEF DESCRIPTION OF THE DRAWINGS

The description herein makes reference to the accompanying drawings wherein like reference numerals refer to like parts throughout the figures.

FIG. 1 illustrates a data processing system in accordance with an embodiment of the disclosure.

FIG. 2 shows a data processing system including a memory system in accordance with an embodiment of the disclosure.

FIG. 3 illustrates a memory system in accordance with an embodiment of the disclosure.

FIG. 4 shows a first example of out-of-band (OOB) communication in a data processing system according to an embodiment of the disclosure.

FIGS. 5A and 5B describe first examples for generating or transferring a pulse used for OOB communication according to an embodiment of the disclosure.

FIG. 6 illustrates a second example for generating or transferring a pulse used for OOB communication according to an embodiment of the disclosure.

FIG. 7 describes a code configuration of OOB communication according to an embodiment of the disclosure.

FIG. 8 illustrates a first operation of the data processing system according to an embodiment of the disclosure.

FIG. 9 illustrates a second operation of the data processing system according to an embodiment of the disclosure.

FIG. 10 shows a third operation of the data processing system according to an embodiment of the disclosure.

FIG. 11 describes a pulse used for a packet in an OOB communication way according to an embodiment of the disclosure.

FIGS. 12A to 12I illustrate a packet configuration used in an OOB communication way according to an embodiment of the disclosure.

FIG. 13 shows a first example of specifications used in an OOB communication way according to an embodiment of the disclosure.

FIG. 14 shows a second example of specifications used in an OOB communication way according to an embodiment of the disclosure.

FIG. 15 illustrates a third example of specifications used in an OOB communication way according to an embodiment of the disclosure.

FIG. 16 describes a fourth example of specifications used in an OOB communication way according to an embodiment of the disclosure.

FIG. 17 shows a method for operating a memory system according to an embodiment of the disclosure.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### DETAILED DESCRIPTION

Various embodiments of the disclosure are described below with reference to the accompanying drawings. Elements and features of the disclosure, however, may be configured or arranged differently to form other embodiments, which may be variations of any of the disclosed embodiments.

In this disclosure, the terms “comprise,” “comprising,” “include” and “including” are open-ended. As used in the appended claims, these terms specify the presence of the stated elements and do not preclude the presence or addition of one or more other elements. The terms in a claim does not preclude the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware, for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used herein, these terms are used as labels for nouns that the terms precede, and do not imply any type of ordering (e.g., spatial, temporal, logical, etc.). The terms “first” and “second” do not necessarily imply that the first value must be written before the second value. Further, although the terms “first”, “second”, “third”, and so on may be used herein to identify various elements, these elements are not limited by these terms. These terms are used to distinguish one element from another element that otherwise have the same or similar names. For example, a first circuitry may be distinguished from a second circuitry.

Further, this term “based on” is used to describe one or more factors that affect a determination. This term does not preclude additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the disclosure provides a data processing system and a method for operating the data processing system, which includes components and resources such as a memory system and a host, and is capable of dynamically allocating plural data paths used for data communication between the components based on usages of the components and the resources.

An embodiment of the disclosure can provide an apparatus or a method for transferring an operational status of a memory system in an out-of-band communication way without affecting a data input/output (I/O) speed (e.g., I/O throughput) to an external device (e.g. a host) so that the external device can recognize the operational status of the memory and fully utilize a resource included in the memory system.

An embodiment of the disclosure can provide an apparatus or a method applicable to a data processing system including a host and a memory system. The apparatus or the method can be implemented for transferring or receiving an operational status regarding data input or data output between the host and the memory system in an out-of-band communication way using power detection or peripheral component (e.g., LED or the like) control, not in an in-band communication way using a data transmission line for delivering requests and pieces of data. Accordingly, the apparatus or the method can reduce overhead caused by transmission of the operational status during data input/output operations.

An embodiment of the disclosure can provide a method for establishing a protocol or a standard regarding how to communicate a memory system with a host to transfer an operational status of the memory system, or an apparatus for transferring the operation status of the memory system, which is encoded according to the protocol or the standard. The protocol or the standard can suggest how to encode the operation status of the memory system, and how to transfer encoded data in an out-of-band communication way using a peripheral inactive line between the memory system and the host without adding an additional transceiver, an additional port/pin or an additional communication line.

In an embodiment, a data processing system can include a memory system configured to transfer to, or receive from, a host, a piece of data in an in-band communication way. The memory system can be configured to transfer a packet to the host in an out-of-band communication way, and the packet includes a first type item, including a parameter regarding an idle status, a data input/output processing status and a status showing a sequential or random write operation in the memory system, and a second type item including a variable corresponding to the parameter.

The data input/output processing status can indicate whether an input/output throughput of the memory system is slower than a first reference based on a task handled in the memory system.

The task can include a process performed for a read operation, a background operation, a data migration operation or a data copy operation.

The status showing the sequential write operation can be determined according to a result of comparing a second reference with an amount of remaining data to be stored in the memory system in response to a sequential write request inputted from the host.

The status showing the random write operation can be determined according to a result of comparing a third reference with an amount of remaining data to be stored in the memory system in response to a random write request inputted from the host.

The memory system can be configured to transfer the packet to the host regardless of host's request.

The first type item can further include another parameter regarding an internal temperature of the memory system, and the second type item can further include a variable corresponding to the another parameter.

The first type item can further include one of identification information of the memory system and log information regarding the plural parameters and the plural variables transferred through the out-of-band communication way.

The packet can further include a first variable indicating a beginning of the packet and a second variable used for checking a data error included in the packet.

The packet can include a pulse having a preset number of cycles, each cycle includes an active state and an inactive state which have equal time. A length of each cycle can be determined based on a length of each active state.

The first type item, the second type item, the first variable and the second variable can independently include at least one nibble, the nibble showing 4-bit data in a single cycle of the pulse.

The packet can include the first variable and the first type item independently implemented with a single cycle of the pulse, the second type item implemented with four cycles of the pulse, and the second variable implemented with three cycles of the pulse.

The memory system can be further configured to maintain a communication line for the out-of-band communication way is in an inactive state for more than twice as long as the shortest cycle after completing transmission of the packet.

In another embodiment, a memory system can include a memory device including plural non-volatile memory cells; and a controller configured to perform, in response to a request inputted from a host in an in-band communication way, an operation for storing a piece of data in the memory device or outputting the piece of data stored in the memory device. The controller can be configured to, based on a status of the operation, transfer a packet to the host through an out-of-band communication way. The packet may include a first type item, including a parameter regarding an idle status, a data input/output processing status, a status showing a sequential or random write operation and an internal temperature in the memory system, and a second type item including a variable corresponding to the parameter.

The data input/output processing status can indicate whether an input/output throughput of the memory system is slower than a first reference based on a task handled in the memory system.

The status showing the sequential write operation can be determined according to a result of comparing a second reference with an amount of remaining data to be stored in the memory system in response to a sequential write request inputted from the host. The status showing the random write operation can be determined according to a result of comparing a third reference with an amount of remaining data to be stored in the memory system in response to a random write request inputted from the host.

The packet can further include a first variable indicating a beginning of the packet and a second variable used for checking a data error included in the packet.

The packet can include the first variable and the first type item independently implemented with a single cycle of the pulse, the second type item implemented with four cycles of the pulse, and the second variable implemented with three cycles of the pulse.

The memory system can be configured to maintain that a communication line for the out-of-band communication way is in an inactive state for more than twice as long as a cycle of the packet including a pulse of a preset number of cycles after completing transmission of the packet.

In another embodiment, a method for operating a memory system can include monitoring statuses of tasks performed for a foreground operation or a background operation; transferring a result or a response of the foreground operation to an external device through an in-band communication way; and transferring a packet, which is determined based on the statuses of the tasks, to the external device through an out-of-band communication way. The packet may include a first type item, including a parameter regarding an idle status, a data input/output processing status and a status showing a sequential or random write operation in the memory system, and a second type item including a variable corresponding to the parameter.

An operating method of a data processing system including a host and a memory system may include: communicating, by the host and the memory system, with each other in relation to a memory operation of the memory system according to an in-band communication scheme; and communicating, by the host and the memory system, with each other in relation to an idle/busy status, an input/output status, a status of a sequential write operation and a status of a random write operation of the memory system according to an out-of-band communication scheme.

Embodiments of the disclosure will now be described with reference to the accompanying drawings, wherein like numbers reference like elements.

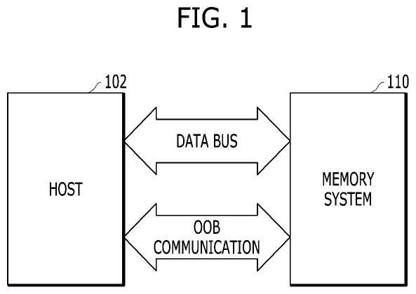

FIG. 1 shows a data processing system in accordance with an embodiment of the disclosure.

Referring to FIG. 1, a data processing system may include a host 102 and a memory system 110. The host 102 and the memory system 110 may communicate with each other in two different ways.

The host 102 and the memory system 110 may transmit and receive a request and a result of performing an operation in response to the request through a data bus. Herein, the data bus may include a plurality of communication lines used for data transmission, e.g., data input/output (I/O). When performance required for the host 102 and the memory system 110 in the data processing system is low, it may be that a request and a piece of data are transferred between the host 102 and the memory system 110 through one communication line. However, when a data storage capacity of the memory system 110 increases and a large amount of data is stored in, or outputted from, the memory system 110, the data bus may include the plurality of communication lines. Each communication line may connect two pins or two ports of the host 102 and the memory system 110. Communication, i.e., sending or receiving requests, commands, pieces of data, or the like through a communication line such as the data bus between the host 102 and the memory system 110 may be referred to as an in-band communication.

The in-band communication may typically include transmitting or receiving a piece of data through bands, channels, ports, and connections established for data communication between two different devices. However, an out-of-band (OOB) communication, which is distinguished from in-band communication, may support data transmission through another band or channel, port, or connection other than the bands or the channels, the ports, or the connections established for the in-band communication between two different devices. In an OOB communication way, a piece of data may be transferred over another means which is not generally used for plural pieces of data. For example, the OOB communication can transmit or receive a piece of data in another band (e.g., frequency, speed, etc.) other than a preset band (e.g., frequency, speed, etc.) used for the in-band communication via a communication path between two different devices. Depending on an embodiment, in the OOB communication way, a data communication line or channel used for the in-band communication (e.g., a data input/output (I/O) line) capable of transmitting and receiving addresses, commands, addresses or etc. bi-directionally are not used. But, a path, a line or a wire for other purposes or uses between different devices or components are used for transferring a piece of data or information in the OOB communication way. For example, the path, the line or the wire for other purposes or uses may include a line used for testing a device, a reserved line used for supplying a clock, power or etc., and an additional line created for use between a manufacturer and a vendor. Referring to FIG. 1, the host 102 and the memory system 110 can support a connection for the OOB communication. Although not shown, in an embodiment, the host 102 and the memory system 110 may perform the OOB communication through an interface designed for performing the in-band communication. In another embodiment, the host 102 or the memory system 110 may include an additional interface for performing the OOB communication.

A connection for the OOB communication may generally have a lower performance in a view of data transfer rate or data transfer width than a connection for the in-band communication such as a data bus between the host 102 and the memory system 110. Thus, the connection for the OOB communication between the host 102 and the memory system 110 may not be applicable for transferring a piece of data from the host 102 to the memory system 110 or vice versa. In an embodiment of the data processing system, the OOB communication has been used for the purpose of transmitting and receiving a piece of data or a signal, which is simple and may not be affected by processing speed, such as power-related information or information regarding device recognition.

A high data input/output speed (e.g., I/O throughput) may be required from the memory system 110 included in the data processing system according to an embodiment of the disclosure. A rate of transferring or receiving a request or a piece of data over the data bus between the memory system 110 and the host 102 may be increased depending on a data I/O speed of the memory system 110. When an internal configuration of the memory system 110 becomes complicated or many functions (or better performance) are required from the memory system 110, a lot of signals or various types of signals may be transferred or exchanged between the memory system 110 and the host 102. For example, a signal transferred between the host 102 and the memory system 110 may include information regarding an operational status of the memory system 110 in addition to a read request, a write request and a piece of data corresponding to the read request or the write request.

When the information regarding the operational status of the memory system 110 is transmitted to the host 102, the host 102 may determine a more efficient manner, order and the like for using the memory system 110. For example, before the host 102 transmits a write command and a piece of data to the memory system 110, the host 102 may recognize, based on the information, that the memory system 110 may not immediately perform an operation in response to the write request because the memory system 110 handles another request that has already been transferred. In this case, after another piece of data is issued or generated by another operation in the host 102, the host 102 may gather pieces of data and transfer gathered data with a write request to the memory system 110. Accordingly, when the host 102 can obtain the information regarding the operational status of the memory system 110, the host 102 may select or determine one of various ways regarding how to process or handle plural pieces of data faster.

Over the data bus in the in-band communication way, the host 102 may transmit a request or a command to recognize an operational status of the memory system 110, and the memory system 110 may send a response including the operational status to the host 102. However, the request and the response regarding the operational status of the memory system 110 may cause a delay in data transmission (e.g., data input/output) between the host 102 and the memory system 110. That is, a process of transmitting and receiving the operational status of the memory system 110 may worsen or drop performance of the data processing system. Thus, in an embodiment of the disclosure, the operational status of the memory system 110 may be transferred in the OOB communication way between the host 102 and the memory system 110, to reduce or avoid overheads in the data input/output (I/O) operations.

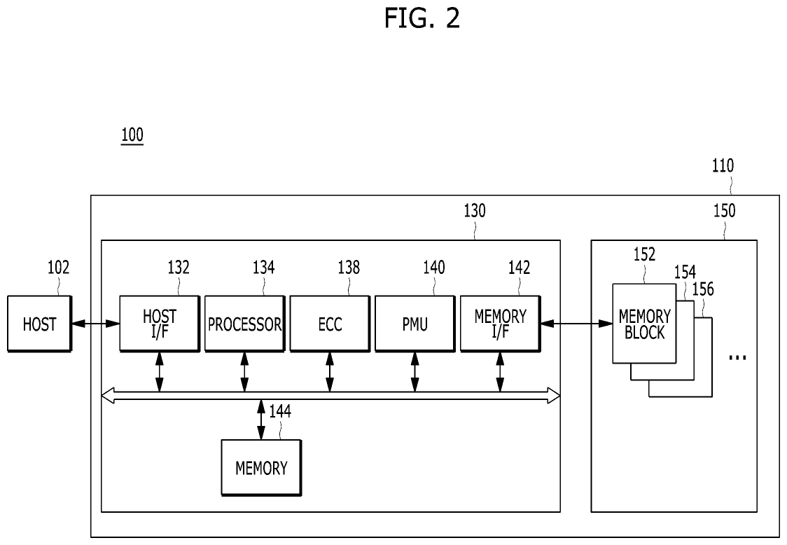

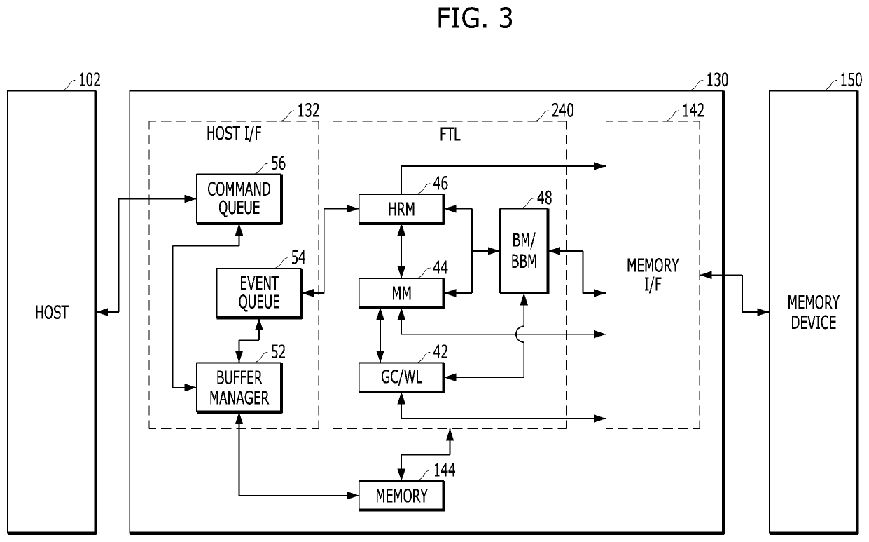

Hereinafter, referring to FIGS. 2 and 3, some operations performed by the memory system 110 are described in detail.

Referring to FIG. 2, a data processing system 100 in accordance with an embodiment of the disclosure is described. Referring to FIG. 2, the data processing system 100 may include a host 102 engaged or interlocked with a memory system 110.

The host 102 may include, for example, a portable electronic device such as a mobile phone, an MP3 player and a laptop computer, or a non-portable electronic device such as a desktop computer, a game player, a television (TV), a projector and the like.

The host 102 also includes at least one operating system (OS), which can generally manage, and control, functions and operations performed in the host 102. The OS can provide interoperability between the host 102 engaged with the memory system 110 and the user needing and using the memory system 110. The OS may support functions and operations corresponding to user's requests. By way of example but not limitation, the OS can be classified into a general operating system and a mobile operating system according to mobility of the host 102. The general operating system may be split into a personal operating system and an enterprise operating system according to system requirements or a user's environment. But the enterprise operating systems can be specialized for securing and supporting high performance. The mobile operating system may be subject to support services or functions for mobility (e.g., a power saving function). The host 102 may include a plurality of operating systems. The host 102 may execute multiple operating systems interlocked with the memory system 110, corresponding to a user's request. The host 102 may transmit a plurality of commands corresponding to the user's requests into the memory system 110, thereby performing operations corresponding to commands within the memory system 110.

The controller 130 in the memory system 110 may control the memory device 150 in response to a request or a command inputted from the host 102. For example, the controller 130 may perform a read operation to provide a piece of data read from the memory device 150 for the host 102, and perform a write operation (or a program operation) to store a piece of data inputted from the host 102 in the memory device 150. In order to perform data input/output (I/O) operations, the controller 130 may control and manage internal operations for data read, data program, data erase, or the like.

According to an embodiment, the controller 130 can include a host interface 132, a processor 134, error correction circuitry 138, a power management unit (PMU) 140, a memory interface 142, and a memory 144. Components included in the controller 130 described in FIG. 2 may vary according to an implementation form, an operation performance, or the like regarding the memory system 110. For example, the memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like. Components in the controller 130 may be added or omitted based at implementation of the memory system 110.

As used in the disclosure, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term ‘circuitry’ also covers an implementation of merely a processor (or multiple processors) or portion of a processor and its (or their) accompanying software and/or firmware. The term ‘circuitry’ also covers, for example, and if applicable to a particular claim element, an integrated circuit for a storage device.

The host 102 and the memory system 110 may include a controller or an interface for transmitting and receiving a signal, a piece of data, and the like, under a predetermined protocol. For example, the host interface 132 in the memory system 110 may include an apparatus capable of transmitting a signal, a piece of data, and the like to the host 102 or receiving a signal, a piece of data, and the like inputted from the host 102.

The host interface 132 included in the controller 130 may receive a signal, a command (or a request), or a piece of data inputted from the host 102. That is, the host 102 and the memory system 110 may use a predetermined protocol to transmit and receive a piece of data between each other. An example of protocols or interfaces, supported by the host 102 and the memory system 110 for sending and receiving a piece of data, can include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIE), Serial-attached SCSI (SAS), Serial Advanced Technology Attachment (SATA), Mobile Industry Processor Interface (MIPI), and the like. According to an embodiment, the host interface 132 is a type of layer for exchanging a piece of data with the host 102 and is implemented with, or driven by, firmware called a host interface layer (HIL).

The Integrated Drive Electronics (IDE) or Advanced Technology Attachment (ATA), used as one of the interfaces for transmitting and receiving a piece of data, can use a cable including 40 wires connected in parallel to support data transmission and reception between the host 102 and the memory system 110. When a plurality of memory systems 110 are connected to a single host 102, the plurality of memory systems 110 may be divided into a master or a slave by using a position or a dip switch to which the plurality of memory systems 110 are connected. The memory system 110 set as the master may be used as the main memory device. The IDE (ATA) has evolved into Fast-ATA, ATAPI, and Enhanced IDE (EIDE).

Serial Advanced Technology Attachment (SATA) is a type of serial data communication interface that is compatible with various ATA standards of parallel data communication interfaces which are used by Integrated Drive Electronics (IDE) devices. The 40 wires in the IDE interface can be reduced to six wires in the SATA interface. For example, 40 parallel signals for the IDE can be converted into 6 serial signals for the SATA to be transmitted between each other. The SATA has been widely used because of its faster data transmission and reception rate and it utilizes less resource consumption in the host 102 used for data transmission and reception. The SATA may support connection with up to 30 external devices to a single transceiver included in the host 102. In addition, the SATA can support hot plugging that allows an external device to be attached or detached from the host 102 even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely detached like an external hard disk.

The Small Computer System Interface (SCSI) is a type of serial data communication interface used for connection between a computer, a server, and/or another peripheral device. The SCSI can provide a high transmission speed, as compared with other interfaces such as the IDE and the SATA. In the SCSI, the host 102 and at least one peripheral device (e.g., the memory system 110) are connected in series, but data transmission and reception between the host 102 and each peripheral device may be performed through a parallel data communication. In the SCSI, it is easy to connect to, or disconnect from, the host 102 a device such as the memory system 110. The SCSI can support connections of 15 other devices to a single transceiver included in host 102.

The Serial Attached SCSI (SAS) can be understood as a serial data communication version of the SCSI. In the SAS, not only the host 102 and a plurality of peripheral devices are connected in series, but also data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a type of interface based at least on a Peripheral Component Interconnect Express (PCIe) designed to increase performance and design flexibility of the host 102, servers, computing devices, and the like equipped with the non-volatile memory system 110. Here, the PCIe can use a slot or a specific cable for connecting the host 102, such as a computing device, and the memory system 110, such as a peripheral device. For example, the PCIe can use a plurality of pins (for example, 18 pins, 32 pins, 49 pins, 82 pins, etc.) and at least one wire (e.g. ×1, ×4, ×8, ×16, etc.), to achieve high speed data communication over several hundred MB per second (e.g. 250 MB/s, 500 MB/s, 984.6250 MB/s, 1969 MB/s, and etc.). According to an embodiment, the PCIe scheme may achieve bandwidths of tens to hundreds of Giga bits per second. A system using the NVMe can make the most of an operation speed of the nonvolatile memory system 110, such as an SSD, which operates at a higher speed than a hard disk.

According to an embodiment, the host 102 and the memory system 110 may be connected through a universal serial bus (USB). The Universal Serial Bus (USB) is a type of scalable, hot-pluggable plug-and-play serial interface that can provide cost-effective standard connectivity between the host 102 and a peripheral device such as a keyboard, a mouse, a joystick, a printer, a scanner, a storage device, a modem, a video camera, and the like. A plurality of peripheral devices such as the memory system 110 may be coupled to a single transceiver included in the host 102.

Referring to FIG. 2, the error correction code circuitry (ECC) 138 can correct error bits of the data to be processed in (e.g., outputted from) the memory device 150, which may include an ECC encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in a data read from the memory device 150 when the controller 130 reads the data stored in the memory device 150. In other words, after performing error correction decoding on the data read from the memory device 150, the ECC circuitry 138 can determine whether the error correction decoding has succeeded and output an instruction signal (e.g., a correction success signal or a correction fail signal). The ECC circuitry 138 can use the parity bit which is generated during the ECC encoding process, for correcting the error bit of the read data. When the number of the error bits is greater than or equal to a threshold number of correctable error bits, the ECC circuitry 138 may not correct error bits but instead may output an error correction fail signal indicating failure in correcting the error bits.

According to an embodiment, the ECC circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC circuitry 138 may include circuits, modules, systems or devices for performing the error correction operation based on at least one of the above described codes.

The power management unit (PMU) 140 may control electrical power provided in the controller 130. The PMU 140 may monitor the electrical power supplied to the memory system 110 (e.g., a voltage supplied to the controller 130) and provide the electrical power to components included in the controller 130. The PMU 140 can not only detect power-on or power-off, but also can generate a trigger signal to enable the memory system 110 to back up a current state urgently when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the memory device 150, to allow the controller 130 to control the memory device 150 in response to a command or a request inputted from the host 102. The memory interface 142 may generate a control signal for the memory device 150 and may process data inputted to, or outputted from, the memory device 150 under the control of the processor 134 in a case when the memory device 150 is a flash memory. For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) as a component for exchanging data with the memory device 150.

According to an embodiment, the memory interface 142 may support an open NAND flash interface (ONFi), a toggle mode or the like for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), and a toggle double data rate (DDR).

The memory 144 may be a type of working memory in the memory system 110 or the controller 130, while storing temporary or transactional data which occurred or was delivered for operations in the memory system 110 and the controller 130. For example, the memory 144 may temporarily store a piece of read data outputted from the memory device 150 in response to a request from the host 102, before the piece of read data is outputted to the host 102. In addition, the controller 130 may temporarily store a piece of write data inputted from the host 102 in the memory 144, before programming the piece of write data in the memory device 150. When the controller 130 controls operations such as data read, data write, data program, data erase or etc. of the memory device 150, a piece of data transmitted or generated between the controller 130 and the memory device 150 of the memory system 110 may be stored in the memory 144. In addition to the piece of read data or write data, the memory 144 may store information (e.g., map data, read requests, program requests, etc.) necessary for performing operations for inputting or outputting a piece of data between the host 102 and the memory device 150. According to an embodiment, the memory 144 may include a command queue, a program memory, a data memory, a write buffer/cache, a read buffer/cache, a data buffer/cache, a map buffer/cache, and the like.

In an embodiment, the memory 144 may be implemented with a volatile memory. For example, the memory 144 may be implemented with a static random access memory (SRAM), a dynamic random access memory (DRAM), or both. Although FIG. 2 illustrates, for example, the memory 144 disposed within the controller 130, the embodiments are not limited thereto. The memory 144 may be located within or external to the controller 130. For instance, the memory 144 may be embodied by an external volatile memory having a memory interface transferring data and/or signals between the memory 144 and the controller 130.

The processor 134 may control the overall operations of the memory system 110. For example, the processor 134 can control a program operation or a read operation of the memory device 150, in response to a write request or a read request entered from the host 102. According to an embodiment, the processor 134 may execute firmware to control the program operation or the read operation in the memory system 110. Herein, the firmware may be referred to as a flash translation layer (FTL). An example of the FTL is later described in detail, referring to FIG. 3. According to an embodiment, the processor 134 may be implemented with a microprocessor or a central processing unit (CPU).

According to an embodiment, the memory system 110 may be implemented with at least one multi-core processor. The multi-core processor is a type of circuit or chip in which two or more cores, which are considered distinct processing regions, are integrated. For example, when a plurality of cores in the multi-core processor drive or execute a plurality of flash translation layers (FTLs) independently, data input/output speed (or performance) of the memory system 110 may be improved. According to an embodiment, the data input/output (I/O) operations in the memory system 110 may be independently performed through different cores in the multi-core processor.

The processor 134 in the controller 130 may perform an operation corresponding to a request or a command inputted from the host 102. Further, the memory system 110 may be independent of a command or a request inputted from an external device such as the host 102. Typically, an operation performed by the controller 130 in response to the request or the command inputted from the host 102 may be considered a foreground operation, while an operation performed by the controller 130 independently (e.g., regardless the request or the command inputted from the host 102) may be considered a background operation. The controller 130 can perform the foreground or background operation for read, write or program, erase and the like regarding a piece of data in the memory device 150. In addition, a parameter set operation corresponding to a set parameter command or a set feature command as a set command transmitted from the host 102 may be considered a foreground operation. Furthermore, as a background operation without a command transmitted from the host 102, the controller 130 can perform garbage collection (GC), wear leveling (WL), bad block management for identifying and processing bad blocks, or the like, in relation to a plurality of memory blocks 152, 154, 156 included in the memory device 150.

According an embodiment, substantially similar operations may be performed as both the foreground operation and the background operation. For example, if the memory system 110 performs garbage collection in response to a request or a command inputted from the host 102 (e.g., Manual GC), garbage collection can be considered a foreground operation. However, when the memory system 110 performs garbage collection independently of the host 102 (e.g., Auto GC), garbage collection can be considered a background operation.

When the memory device 150 includes a plurality of dies (or a plurality of chips) including non-volatile memory cells, the controller 130 may be configured to perform parallel processing regarding plural requests or commands inputted from the host 102 to improve performance of the memory system 110. For example, the transmitted requests or commands may be divided and processed simultaneously into a plurality of dies or a plurality of chips in the memory device 150. The memory interface 142 in the controller 130 may be connected to a plurality of dies or chips in the memory device 150 through at least one channel and at least one way. When the controller 130 distributes and stores pieces of data in the plurality of dies through each channel or each way in response to requests or a commands associated with a plurality of pages including nonvolatile memory cells, plural operations corresponding to the requests or the commands can be performed simultaneously or in parallel. Such a processing method or scheme can be considered as an interleaving method. Because data input/output speed of the memory system 110 operating with the interleaving method may be faster than that without the interleaving method, data I/O performance of the memory system 110 can be improved.

By way of example but not limitation, the controller 130 can recognize statuses regarding a plurality of channels (or ways) associated with a plurality of memory dies included in the memory device 150. The controller 130 may determine the status of each channel or each way as one of a busy status, a ready status, an active status, an idle status, a normal status and/or an abnormal status. The controller's determination of which channel or way an instruction (and/or a data) is delivered through can be associated with a physical block address, e.g., which die(s) the instruction (and/or the data) is delivered into. The controller 130 can refer to descriptors delivered from the memory device 150. The descriptors can include a block or page of parameters that describe something about the memory device 150, which is data with a predetermined format or structure. For instance, the descriptors may include device descriptors, configuration descriptors, unit descriptors, and the like. The controller 130 can refer to, or use, the descriptors to determine which channel(s) or way(s) an instruction or a data is exchanged via.

Referring to FIG. 2, the memory device 150 in the memory system 110 may include the plurality of memory blocks 152, 154, 156. Each of the plurality of memory blocks 152, 154, 156 includes a plurality of nonvolatile memory cells. According to an embodiment, the memory block 152, 154, 156 can be a group of nonvolatile memory cells erased together. The memory block 152, 154, 156 may include a plurality of pages which is a group of nonvolatile memory cells read or programmed together. Although not shown in FIG. 2, each memory block 152, 154, 156 may have a three-dimensional stack structure for a high integration. Further, the memory device 150 may include a plurality of dies, each die including a plurality of planes, each plane including the plurality of memory blocks 152, 154, 156. Configuration of the memory device 150 can be different for performance of the memory system 110.

In the memory device 150 shown in FIG. 2, the plurality of memory blocks 152, 154, 156 are included. The plurality of memory blocks 152, 154, 156 can be any of different types of memory blocks such as a single level cell (SLC) memory block, a multi-level cell (MLC) memory block or the like, according to the number of bits that can be stored or represented in one memory cell. Here, the SLC memory block includes a plurality of pages implemented by memory cells, each storing one bit of data. The SLC memory block can have high data I/O operation performance and high durability. The MLC memory block includes a plurality of pages implemented by memory cells, each storing multi-bit data (e.g., two bits or more). The MLC memory block can have larger storage capacity for the same space compared to the SLC memory block. The MLC memory block can be highly integrated in view of storage capacity. In an embodiment, the memory device 150 may be implemented with MLC memory blocks such as a double level cell (DLC) memory block, a triple level cell (TLC) memory block, a quadruple level cell (QLC) memory block and a combination thereof. The double level cell (DLC) memory block may include a plurality of pages implemented by memory cells, each capable of storing 2-bit data. The triple level cell (TLC) memory block can include a plurality of pages implemented by memory cells, each capable of storing 3-bit data. The quadruple level cell (QLC) memory block can include a plurality of pages implemented by memory cells, each capable of storing 4-bit data. In another embodiment, the memory device 150 can be implemented with a block including a plurality of pages implemented by memory cells, each capable of storing 5-bit or more bit data.

According to an embodiment, the controller 130 may use a multi-level cell (MLC) memory block included in the memory system 150 as an SLC memory block that stores one-bit data in one memory cell. A data input/output speed of the multi-level cell (MLC) memory block can be slower than that of the SLC memory block. That is, when the MLC memory block is used as the SLC memory block, a margin for a read or program operation can be reduced. The controller 130 can utilize a faster data input/output speed of the multi-level cell (MLC) memory block when using the multi-level cell (MLC) memory block as the SLC memory block. For example, the controller 130 can use the MLC memory block as a buffer to temporarily store a piece of data, because the buffer may require a high data input/output speed for improving performance of the memory system 110.

Further, according to an embodiment, the controller 130 may program pieces of data in a multi-level cell (MLC) a plurality of times without performing an erase operation on a specific MLC memory block included in the memory system 150. In general, nonvolatile memory cells have a feature that does not support data overwrite. However, the controller 130 may use a feature in which a multi-level cell (MLC) may store multi-bit data, in order to program plural pieces of 1-bit data in the MLC a plurality of times. For an MLC overwrite operation, the controller 130 may store the number of program times as separate operation information when a piece of 1-bit data is programmed in a nonvolatile memory cell. According to an embodiment, an operation for uniformly levelling threshold voltages of nonvolatile memory cells can be carried out before another piece of data is overwritten in the same nonvolatile memory cells.

In an embodiment of the disclosure, the memory device 150 is embodied as a nonvolatile memory such as a flash memory such as a NAND flash memory, a NOR flash memory and the like. Alternatively, the memory device 150 may be implemented by at least one of a phase change random access memory (PCRAM), a ferroelectrics random access memory (FRAM), a spin injection magnetic memory (SU-RAM), and a spin transfer torque magnetic random access memory (STT-MRAM), or the like.

Referring to FIG. 3, a controller in a memory system in accordance with an embodiment of the disclosure is described. The controller 130 cooperates with the host 102 and the memory device 150. As illustrated, the controller 130 includes a host interface 132, a flash translation layer (FTL) 240, as well as the host interface 132, the memory interface 142 and the memory 144, such as those shown in FIG. 2.

Although not shown in FIG. 3, in accordance with an embodiment, the ECC circuitry 138 described in FIG. 2 may be included in the flash translation layer (FTL) 240. In another embodiment, the ECC circuitry 138 may be implemented as a separate module, a circuit, firmware or the like, which is included in, or associated with, the controller 130.

The host interface 132 may handle commands, data, and the like transmitted from the host 102. By way of example but not limitation, the host interface 132 may include a command queue 56, a buffer manager 52 and an event queue 54. The command queue 56 may sequentially store commands, data, and the like received from the host 102 and output them to the buffer manager 52 in an order in which they are stored. The buffer manager 52 may classify, manage or adjust the commands, the data, and the like, which are received from the command queue 56. The event queue 54 may sequentially transmit events for processing the commands, the data, and the like received from the buffer manager 52.

A plurality of commands or data of the same characteristic, e.g., read or write commands, may be transmitted from the host 102, or commands and data of different characteristics may be transmitted to the memory system 110 after being mixed or jumbled by the host 102. For example, a plurality of commands for reading data (read commands) may be delivered, or commands for reading data (read command) and programming/writing data (write command) may be alternately transmitted to the memory system 110. The host interface 132 may store commands, data, and the like, which are transmitted from the host 102, to the command queue 56 sequentially. Thereafter, the host interface 132 may estimate or predict what type of internal operation the controller 130 will perform according to the characteristics of commands, data, and the like, which have been entered from the host 102. The host interface 132 can determine a processing order and a priority of commands, data and the like, based at least on their characteristics. According to characteristics of commands, data, and the like transmitted from the host 102, the buffer manager 52 in the host interface 132 is configured to determine whether the buffer manager should store commands, data, and the like in the memory 144, or whether the buffer manager should deliver the commands, the data, and the like into the flash translation layer (FTL) 240. The event queue 54 receives events, entered from the buffer manager 52, which are to be internally executed and processed by the memory system 110 or the controller 130 in response to the commands, the data, and the like transmitted from the host 102, so as to deliver the events into the flash translation layer (FTL) 240 in the order received.

In accordance with an embodiment, the flash translation layer (FTL) 240 described in FIG. 3 may work as a multithread scheme to perform the data input/output (I/O) operations. A multithread FTL may be implemented through a multi-core processor using multi-thread included in the controller 130.

In accordance with an embodiment, the flash translation layer (FTL) 240 can include a host request manager (HRM) 46, a map manager (MM) 44, a state manager (GC/WL) 42 and a block manager (BM/BBM) 48. The host request manager (HRM) 46 can manage the events entered from the event queue 54. The map manager (MM) 44 can handle or control a map data. The state manager 42 can perform garbage collection (GC) or wear leveling (WL). The block manager 48 can execute commands or instructions onto a block in the memory device 150.

By way of example but not limitation, the host request manager (HRM) 46 can use the map manager (MM) 44 and the block manager 48 to handle or process requests according to the read and program commands, and events which are delivered from the host interface 132. The host request manager (HRM) 46 can send an inquiry request to the map data manager (MM) 44, to determine a physical address corresponding to the logical address which is entered with the events. The host request manager (HRM) 46 can send a read request with the physical address to the memory interface 142, to process the read request (handle the events). On the other hand, the host request manager (HRM) 46 can send a program request (write request) to the block manager 48, to program data to a specific empty page (no data) in the memory device 150, and then, can transmit a map update request corresponding to the program request to the map manager (MM) 44, to update an item relevant to the programmed data in information of mapping the logical-physical addresses to each other.

Here, the block manager 48 can convert a program request delivered from the host request manager (HRM) 46, the map data manager (MM) 44, and/or the state manager 42 into a flash program request used for the memory device 150, to manage flash blocks in the memory device 150. In order to maximize or enhance program or write performance of the memory system 110 (see FIG. 2), the block manager 48 may collect program requests and send flash program requests for multiple-plane and one-shot program operations to the memory interface 142. In an embodiment, the block manager 48 sends several flash program requests to the memory interface 142 to enhance or maximize parallel processing of the multi-channel and multi-directional flash controller.

On the other hand, the block manager 48 can be configured to manage blocks in the memory device 150 according to the number of valid pages, select and erase blocks having no valid pages when a free block is needed, and select a block including the least number of valid pages when it is determined that garbage collection is necessary. The state manager 42 can perform garbage collection to move the valid data to an empty block and erase the blocks containing the moved valid data so that the block manager 48 may have enough free blocks (empty blocks with no data). If the block manager 48 provides information regarding a block to be erased to the state manager 42, the state manager 42 checks all flash pages of the block to be erased to determine whether each page is valid. For example, to determine validity of each page, the state manager 42 can identify a logical address recorded in an out-of-band (OOB) area of each page. To determine whether each page is valid, the state manager 42 can compare the physical address of the page with the physical address mapped to the logical address obtained from the inquiry request. The state manager 42 sends a program request to the block manager 48 for each valid page. A mapping table can be updated through the update of the map manager 44 when the program operation is complete.

The map manager 44 can manage a logical-physical mapping table. The map manager 44 can process requests such as queries, updates, and the like, which are generated by the host request manager (HRM) 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request can be sent to the block manager 48 so that a clean cache block is made and the dirty map table may be stored in the memory device 150.

On the other hand, when garbage collection is performed, the state manager 42 copies valid page(s) into a free block, and the host request manager (HRM) 46 can program the latest version of the data for the same logical address of the page and currently issue an update request. When the status manager 42 requests the map update in a state in which copying of valid page(s) is not completed normally, the map manager 44 may not perform the mapping table update. It is because the map request is issued with old physical information if the status manger 42 requests a map update and a valid page copy is completed later. The map manager 44 may perform a map update operation to ensure accuracy only if the latest map table still points to the old physical address.

Referring to FIGS. 1 to 3, the memory system 110 may perform a foreground operation (i.e., an operation in response to a request inputted from the host 102) or a background operation (i.e., an operation regardless of any request inputted from the host 102). According to an embodiment, the memory system 110 may transfer a response of the foreground operation in the in-band communication way, as well as notify an operational status to the host 102 in the OOB communication way.

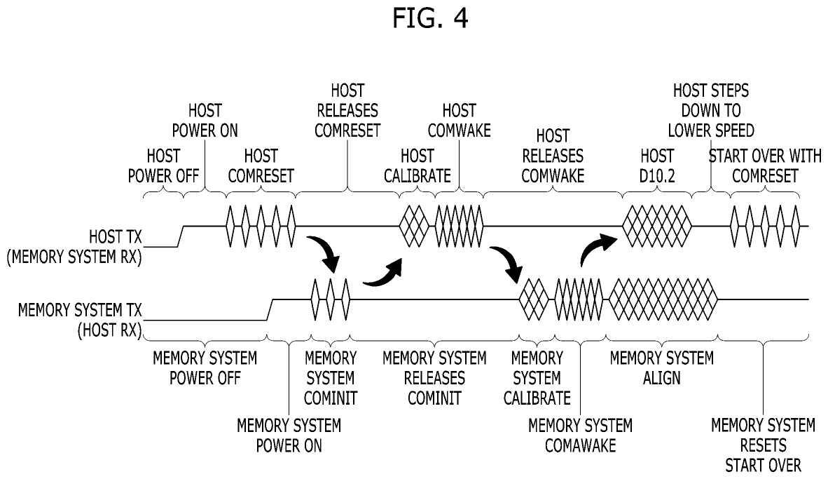

FIG. 4 shows a first example of out-of-band (OOB) communication in a data processing system according to an embodiment of the disclosure. Although not shown in FIGS. 1 to 3, the host 102 and the memory system 110 may independently include a transmitter TX and a receiver RX for performing the OOB communication. A signal outputted from host's transmitter (Host TX) may be received by memory system's receiver (Memory System RX), and a signal outputted from memory system's transmitter (Memory System TX) may be received by host's receiver (Host RX). Specifically, FIG. 4 illustrates an example of a procedure for establishing the OOB communication between the host 102 and the memory system 110.

Referring to FIG. 4, electrical power may be supplied (Host Power On) to a host that is in a power-off status (Host Power Off). The host's transmitter (Host TX) may raise a level of a signal transmitted through the OOB communication way to inform the memory system that the electrical power is applied to the host. The host's transmitter (host TX) may output a reset signal COM RESET. Here, the reset signal COMRESET may be transferred from the host to the memory system. The reset signal may be used as a signal for initializing the OOB communication.

The electrical power is applied to the host as well as the memory system. The memory system may be powered on (Memory System Power On) when the electrical power is supplied with the memory system that is in a power-off status (Memory system Power Off). The memory system receiving the reset signal COMRESET outputted from the host's transmitter (Host TX) may output an initialization signal COMINIT. The initialization signal COMINIT may be transmitted from memory system's transmitter to host's receiver. The initialization signal COMINIT may be used as a response of the reset signal COMRESET used for initializing the OOB communication.

Through the reset signal COMRESET and the initialization signal COMINIT, it is possible to check whether the host and the memory system can perform the OOB communication. When the host recognizes that the OOB communication is available, the host's transmitter (Host TX) can no longer transmit the reset signal COMRESET (Host Releases COM RESET). When the host's transmitter (host TX) does not send the reset signal COMRESET (Host Releases COMRESET), the memory system's transmitter (Memory System TX) does not output the initialization signal COMINIT any longer (Memory System Releases COMINIT).

When both the host and the memory system are in a status capable of performing the OOB communication, the host may perform calibration for the OOB communication (Host Calibrate). After the host performs the calibration, the host may output a communication wake signal COMWAKE to the memory system (Host COMWAKE). The memory system receiving the wake signal COMWAKE outputted from the host's transmitter (Host TX) may perform a calibration (Memory System Calibrate). The host may stop transmitting the wake signal (Host Releases COMWAKE). After performing the calibration, the memory system may output the wake signal COMWAKE to the host as a response (Memory System COMWAKE). While the reset signal COMRESET and the initialization signal COMINIT are types of signals that can be transferred by a specific device, e.g., either the host or the memory system, the wake signal COMWAKE may be a type of signal that can be transmitted and received bi-directionally from the host to the memory system or vice versa. When the host and the memory system exchange the wake signal COMWAKE, a procedure for arranging the OOB communication between the host and the memory system may be completed.

When the OOB communication between the host and the memory system is initialized and arranged, the host and the memory system may determine or negotiate a speed for transferring and receiving a piece of data or information in the OOB communication way (referred as to Speed Negotiation or Speed Determination). For example, after the host and the memory system send to and receive from each other the wake signal COMWAKE, the memory system's transmitter (Memory System TX) may start to send a continuous stream of alignment signals at the highest speed supported by or available to the memory system's transmitter. In response to the continuous stream, the host's transmitter (Host TX) can start transmitting a speed check signal (e.g., D10.2 characters) at a preset speed supported by or available to the host's transmitter. When the host supports the speed at which the memory system's transmitter (Memory System TX) transmits the alignment signals, the host's receiver (Host RX) can determine a communication speed (rate) based on the received alignment signals. The host's transmitter (Host TX) may transmit the speed check signal (e.g., D10.2 characters) to the memory system's receiver (Memory System RX) at the determined speed which is identical with the speed of the alignment signals transferred from the memory system's transmitter. When the host receiver (Host RX) receives the alignment signals at a lower speed than the preset speed, the host may perform speed determination, i.e., adjust/decrease a transmission speed, to match a transmission speed for OOB communication with the speed that the memory system can support (Host Steps Down to Lower Speed). On the other hand, when the host's receiver (Host RX) receives the alignment signals at a higher speed than the preset speed, the host's transmitter (Host TX) may adjust/increase the transmission speed in response to the speed supported by the memory system. During speed determination, the host's transmitter (Host TX) may transmit the reset signal COMRESET, and the host and the memory system may restart OOB communication (Start Over with COMRESET, Memory System Resets Start Over). When a transmission rate for the OOB communication is determined through the above-described procedure, the host and the memory system may transmit and receive a piece of data at the determined rate in the OOB communication way.

In FIG. 4, the host and the memory system can initialize the OOB communication between each other and determine a data transfer rate for the OOB communication. According to an embodiment, the OOB communication between the host and the memory system may be performed without determination on a data transmission rate.

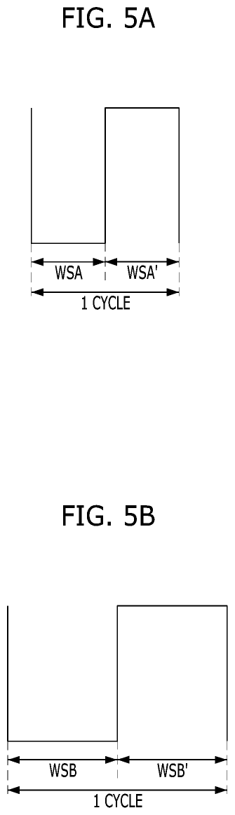

FIGS. 5A and 5B describe first examples about how to generate or transfer a pulse used for OOB communication according to an embodiment of the disclosure. For example, the memory system's transmitter may generate two different signals shown in FIGS. 5A and 5B.

The memory system supporting the OOB communication way may generate a pulse of a preset number of cycles used for transmitting and receiving a piece of data. Referring to FIGS. 5A and 5B, the cycle of the pulse generated by the memory system's transmitter may be different based on a piece of data, a code and the like to be transmitted to the host. The pulse may include an active state WSA, WSB and an inactive state WSA′, WSB′ for a single cycle. The active state WSA or WSB and inactive state WSA′ or WSB′ can have an identical length of time. For example, when the active state WSA of the pulse described in FIG. 5A has a 1 second length, a length of the inactive state WSA′ corresponding to the active state WSA is also 1 second, so that one cycle of the pulse has a 2 second length. The pulse described in FIG. 5B may have a longer period than the pulse described in FIG. 5A. For example, when the active state WSB has a 1.5 second length, the inactive state WSB′ corresponding to the active state WSB has also a 1.5 second length, so that one cycle of the pulse has a 3 second length.

A format (or structure) of data transmitted and received by the memory system and the host through the OOB communication way may be arranged in advance. For example, a piece of data transmitted by the memory system through the OOB communication way may be outputted in a form of a packet having a preset format/structure. A preset format of the packet may include two variables (i.e., one indicating the start and one indicating the end of the packet), and a preset number of bits or bytes arranged between the two variables indicating the start and end of the packet. When a length of the packet is determined and not changeable, the variable indicating the end of the packet may be omitted. For example, a packet may include 10 bits in which a 1-bit data of the packet corresponds to a single cycle of a pulse. The packet may be implemented with a pulse of 10 cycles in total. When the start of the packet is arranged as a pulse having a 1 second length, the first cycle of the pulse of 10 cycles may has a 1 second length. In such a case, the active state of the first cycle may have a 0.5 second length, while the inactive state may have a 0.5 second length.

According to an embodiment, the pulses described in FIGS. 5A and 5B may be applicable to the reset signal COMRESET, the start signal COMINIT or the wake signal COMWAKE which is described in FIG. 4.

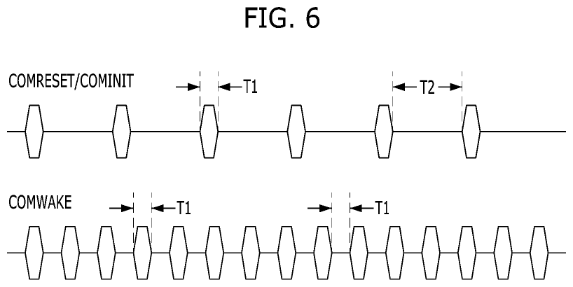

FIG. 6 illustrates a second example of generating or transferring a pulse used for OOB communication according to an embodiment of the disclosure.

Referring to FIG. 6, each cycle of a pulse, which is generated by a transceiver for the OOB communication, can have an active state of identical time length and an inactive state of different time length. For example, the reset signal COMRESET and the start signal COMINIT show in FIG. 4 may be implemented with an identical pulse having an active state T1 and inactive state longer than the active state T1. The wake signal COMWAKE may have an active state T1 having a time length identical with that of the reset signal COMRESET and the start signal COMINIT, but an inactive state of the wake signal COMWAKE may have a different time length from that of the reset signal COMRESET and the start signal COMINIT.

Referring to FIGS. 5A, 5B and 6, a cycle of the pulse transmitted and received through the OOB communication way may be different. In a pulse shown in FIGS. 5A and 5B, time lengths of active and inactive states can be adjusted. But, in a pulse shown in FIG. 6, a time length of an inactive state can be adjusted but a time length of an active state may be fixed. When transmitting and receiving more various types of information and data through the OOB communication way, a pulse described with reference to FIGS. 5A and 5B may be more effective than a pulse shown in FIG. 6.

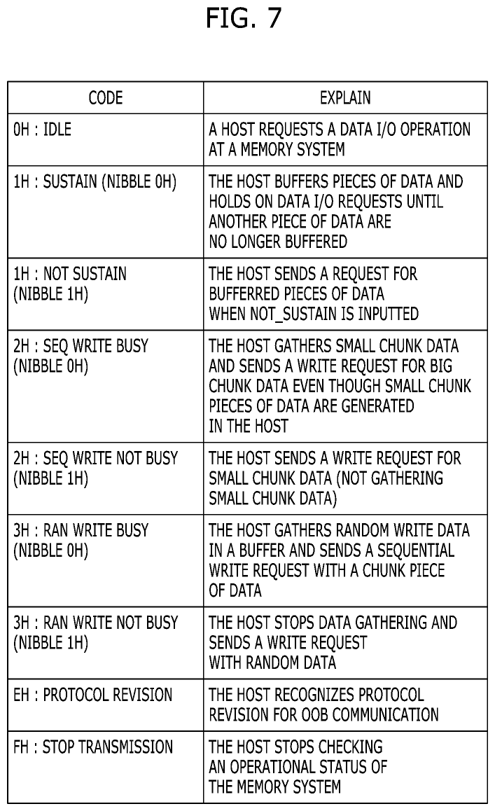

FIG. 7 describes a code configuration of OOB communication according to an embodiment of the disclosure. According to an embodiment, a piece of data transmitted and received through the OOB communication way may be implemented in a packet having a preset format. In order to deliver various types of information or data including an operational status of the memory system through the OOB communication way between the memory system and the host, it may be required to establish configuration of the packet that can be transmitted through the OOB communication way.

Referring to FIG. 7, plural pieces of data or information may be included in the packet as an operational status of the memory system, which may be transmitted through the OOB communication way. A code included in the packet may be configured in order to effectively transmit plural pieces of data regarding the operational status of the memory system to the host. According to an embodiment, the code may be implemented with a nibble representing 4-bit data or information.

In an embodiment, the packet may include a first type item and a second type item. The first type item may include one of plural parameters or codes regarding an idle status, a data input/output processing status and a status showing a sequential or random write operation in the memory system. The second type item may include a variable corresponding to the first type item.

For example, a first code 0H can be used to inform the host of whether the memory system is in an idle status. When the memory system does not transmit any information regarding its idle status (Idle) to the host, the host may determine that the memory system is in the idle status in which the host does not transmit a command or a request for data input/output, such as reading or writing, to the memory system. However, even if no command or request is transmitted from the host to the memory system, the memory system may be performing a background operation or a subsequent operation following a command, or a request, transmitted from the host. That is, when there is a difference between a timing of host's determination and an actual timing of memory system's idle status, performance of the data processing system may not be enhanced. Accordingly, the memory system may transmit to the host an operational status indicating whether the memory system is in the idle status (Idle).

As another example, a second code 1H may be used for the memory system to request a suspension of a request or a command for a data input/output at the host. When the memory system is unable to carry out data I/O requests or commands inputted from the host (Sustain status), the memory system may ask the host for holding a data I/O request or a data I/O command for a time period, e.g., until the memory system is ready to perform another data I/O operation in response to the data I/O request or the data I/O command (not Sustain status). In response to a variable corresponding to the second code 1H, the host may buffer, e.g., temporarily hold, a data input/output request or command before being transmitted to the memory system, and transmit the data input/output request or command stored in a buffer to the memory system when the host recognizes that the memory system is ready to perform another data I/O operation.

As another example, a third code 2H may be used for transferring an operational status of the memory system regarding a sequential write operation to the host, and a fourth code 3H may be used for transferring an operational status of the memory system regarding a random write operation to the host. The sequential and random write operation may be distinguished based on how plural pieces of data are accessed in the memory system. When the current data I/O operation is performed from a physical or logical address immediately after the last physical or logical address of the previous data I/O operation, these data I/O operations can be described as a sequential operation. Otherwise, these data I/O operations can be described as a random operation. Referring to FIGS. 2 to 3, a location (i.e., a physical address) of data stored in the memory device 150 may be determined by the controller 130 of the memory system 110, which may be different from a logical address used by the host. A physical address associated with a logical address is dynamically determined by the controller 130. Physical addresses used for accessing data may not be contiguous while logical addresses for the data are contiguous. A sequential or random operation may be determined based on either physical addresses or logical addresses associated with plural pieces of data. Typically, when sequential write operations are compared with random write operations, the sequential write operations may be completed faster than the random write operations. Further, when a size of write data is small, the sequential write operations may be faster than the random write operations. However, if the size of write data size is larger than a preset amount, parallel processing of writing data may be similarly performed in the memory system so that there is no large difference between operation times of the sequential write operations and the random write operations.

Specifically, when the memory system may transfer, via the third code 2H, to the host that the operational status regarding the sequential write operation is busy, the host may change a size of data associated with a sequential write request from small chunks to a large chunk (a big chunk) before transferring the sequential write request. On the contrary, when the operational status regarding the sequential write operation in the memory system is not busy (not busy), the host sets the size of data associated with the sequential write request from a big chunk to small chunks before transferring the sequential write request. In response to a status regarding the sequential write operation of the memory system, the host may change the size of data transmitted along with a sequential write request, thereby improving a data input/output performance of the data processing system including the host and the memory system.

In addition, when the memory system may transmit, via a variable associated with a fourth code 3H, to the host whether an operational status regarding the random write operation in the memory system is busy, the host may gather write requests, typically causing random write operations in the memory system, in a buffer rather than immediately transmitting the write requests to the memory system, so that plural pieces of data associated with gathered write requests may be changed into a small chunk of data for a sequential write operation and a sequential write request with the small chunk of data is transmitted to the memory system. However, when the operational status regarding the random write operation in the memory system is not busy, the host may transmit a random write request with a piece of data to the memory system without gathering or collecting pieces of data, each piece associated with a random write request, in the buffer. In response to a status regarding the random write operation in the memory system, the host may either change random write requests into a sequential write request or maintain the random write requests, thereby improving the data input/output performance of the data processing system including the host and the memory system.

As another example, a protocol code EH may be used when the memory system may deliver information about a protocol revision into the host. The protocol revision may show a configuration regarding a packet transmitted through the OOB communication way. The host and the memory system may use a protocol used for establishing what kind of data or information can be exchanged through the OOB communication way. For example, if the host and the memory system may recognize previously defined contents as a protocol and there is no change in the contents, the host and the memory system can check a protocol version. However, when the host and the memory system have different protocols or different versions of the protocol used for the OOB communication way, the memory system may transmit information regarding the change of protocol to the host. The information transmitted through the OOB communication way may relate to an operational status of the memory system. The information may include a piece of data that can be transmitted by the memory system rather than requested by the host. It may be important to inform the host of the information which the memory system can transfer through the OOB communication way because the host can recognize a performance of the memory system. Through the protocol code EH, it may be allowed that the memory system transfers information about the version or the change of protocol to the host.

As another example, a stop code FH may be used when the memory system cannot transmit any information to the host through the OOB communication way. When the memory system cannot provide any information regarding the operational status through the OOB communication way, it may be necessary that the memory system informs the host of this situation for improving a performance of the data processing system. For example, when the memory system enters a sleep mode, the memory system may not transmit information about an operational status through the OOB communication way. In this case, when the memory system transmits to the host a packet indicating that the memory system does not provide any information through the OOB communication way, the host may not receive or collect information regarding an operational status through the OOB communication way. According to an embodiment, the memory system may notify the host of a status of the stop transmission after transmitting all prepared information through the OOB communication way, before entering the sleep mode. When the OOB communication is not available to the memory system, the host may try to request an operational status of the memory system and receive a response associated with the operational status through the data bus, which is used in the in-band communication way.

FIG. 7 illustrates an example of codes associated with operational status of the memory system that can be transmitted from the memory system. According to an embodiment, information regarding an operational status of the memory system may be different. Further, according to an embodiment, another code may be provided according to types or characteristics of operational statuses in the memory system, which can be used for improving a performance of the data processing system.

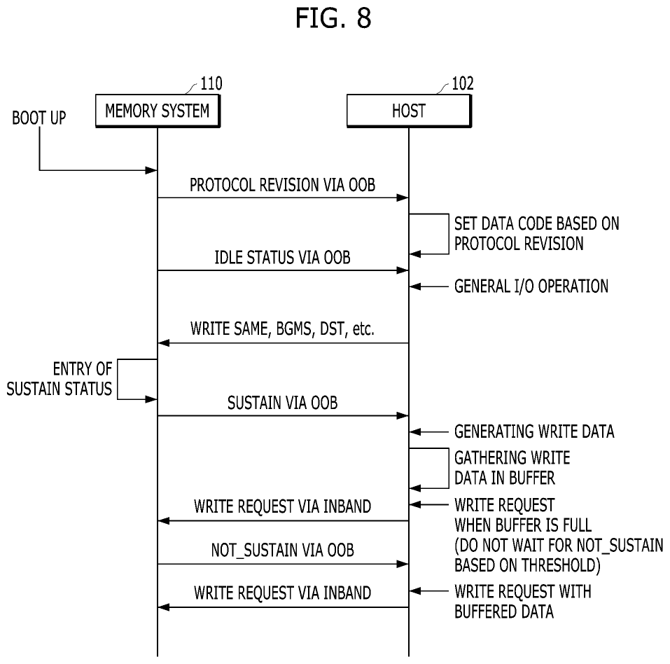

FIG. 8 illustrates a first operation of the data processing system according to an embodiment of the disclosure.

Referring to FIG. 8, the memory system 110 and the host 102 included in the data processing system may prepare and perform plural data input/output (I/O) operations through the OOB communication way and the in-band communication way.

When power is supplied to the memory system 110, the memory system 110 may be booted up. The memory system 110 may transmit information regarding the change of protocol (Protocol Revision) to the host 102 through the OOB communication. The host 102 may decode a packet transmitted from the memory system 110 in response to the change of protocol, after recognizing the change of protocol establishing information transmitted from the memory system 110. For example, the host 102 may set a data code based on the change of protocol.

When a request regarding a data input/output operation is not inputted from the host 102, the memory system 110 may notify the host 102 through the OOB communication way that the memory system 110 is in an idle status. The host 102 can recognize that the memory system 110 is in the idle status and can continue to perform an operation which is previously scheduled or newly requested.

After performing an operation, the host 102 may send a request such as a write same, a background media scan (BGMS), a drive self-test (DST) and the like to the memory system 110. Herein, the write same is a type of request for optimizing a write operation in the memory system 110. For example, the write same is basically a SCSI operation that tells the storage to write a certain pattern (e.g., zeros). The background media scan BGMS may be a self-initiated media scan to perform sequential reads across the entire block of the memory device 150 while the memory system is in an idle status. When the host 102 sends the background media scan to the memory system 110, it is possible that the memory system 110 may be forced to perform the background media scan. The background media scan (BGMS) may be used as a request for improving data retention in the memory system 110. The drive self-test (DST) may be designed to recognize drive fault conditions that indicate that a memory block (or a chip, a plane, etc.) is a failed unit. For example, the DST may perform various tests on the drive and scan locations of the memory device, which is associated with every logical address (LBA). The host 102 may use the drive self-test as a request for checking a physical integrity of the memory device 150.

Because of the write same, the background media scan (BGMS) or the drive self-test (DST) inputted from the host 102, it is difficult for the memory system 110 to perform a data input/output operation corresponding to another request sent by the host 102. Accordingly, the memory system 110 may inform the host 102 of an operational status (Sustain status) in which the data input/output command transmitted by the host 102 may not be immediately performed, through the OOB communication way.

Because the host 102 may recognize that the memory system 110 may not immediately perform a data input/output operation based on the operational status (Sustain status) delivered through the OOB communication way, the host 102 may not send a write request with a write data to the memory system 110, but temporarily hold the write request and the write data in a buffer.

Referring to FIG. 8, if no more requests or data can be stored in the buffer of the host 102, or if an amount of requests or data stored in the buffer is more than a reference value, the host 102 may transfer the buffered requests into the memory system 110. In this case, a write request with a piece of data may be transmitted to the memory system 110 even in the operational status (Sustain state) in which the memory system 110 cannot perform an operation corresponding the write request.

In addition, while the host 102 continues to store requests or data in the buffer, the memory system 110 may become in an operational status (not sustain state) capable of performing an operation corresponding to another data input/output request inputted from the host 102, and can inform the host of the operational status (not sustain status) through the OOB communication way. In response to the operation state of the memory system 110 which is informed through the OOB communication way, the host 102 may transfer buffered requests and data into the memory system 110 through the in-band communication way (e.g., via a data bus).

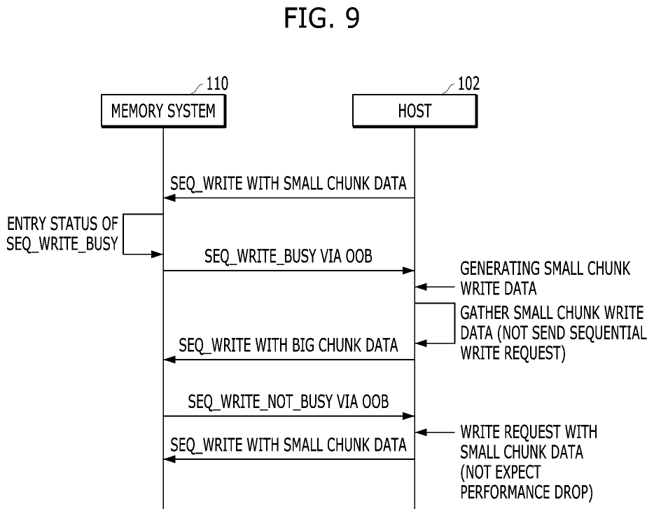

FIG. 9 illustrates a second operation of the data processing system according to an embodiment of the disclosure.

Referring to FIG. 9, the host 102 may transmit a sequential write request with a small chunk of data to the memory system 110. The memory system 110 may store the small chunk of data inputted along with the sequential write request from the host 102. The memory system 110 may perform an operation corresponding to the sequential write request sent by the host 102 and receive another sequential write request. However, due to various reasons (e.g., limited input/output performance of the memory system 110, many sequential write commands from the host 102, and the like), the memory system 110 may become in a busy status (status entry of SEQ_WRITE_BUSY) while performing operations corresponding to the sequential write request previously inputted from the host 102.

Through the OOB communication way, the memory system 110 may inform the host 102 of an operational status of the memory system 110, i.e., the busy status in which the memory system 110 cannot immediately perform an operation corresponding to a sequential write request newly inputted from the host 102.

In the host 102, a sequential write request regarding a small chunk of data may occur. After the host 102 receives the operational status of the memory system 110 and recognizes that the memory system 110 is in the busy status for the sequential write request, the host 102 does not transmit the sequential write request with the small chunk of data, but holds the sequential write request in the buffer. The host 102 may change buffered sequential write requests and small chunks of data, which are collected in the buffer, into another sequential write request with a big chunk of data. The changed sequential write request with the big chunk of data may be used for improving a data input/output performance of the data processing system. Accordingly, the host 102 may transmit the sequential write request with the big chunk of data to the memory system 110.

Herein, sizes of the small chunk and the big chunk may vary depending on an embodiment. By way of example but not limitation, if data having a size larger than 512 bytes is referred to as the big chunk of data, other data having a size smaller than 512 bytes can be referred to as the small chunk of data.

The memory system 110 may perform sequential write requests with small chunks or big chunks of data according to an order inputted from the host 102. When the memory system 110 determines that another operation corresponding to a data input/output request inputted from the host 102 can be immediately performed, the memory system 110 may transmit an operational status (SEG_WRITE_NOT_BUSY) to the host 102 through the OOB communication way.

After the host 102 recognizes that the memory system 110 is not busy for performing an operation corresponding to a sequential write request, the host 102 does not need to hold a sequential write request with a small chunk of data in the buffer, nor convert the sequential write request with a small chunk of data into another sequential write request with a big chunk of data. Because the memory system 110 is not busy for performing an operation corresponding to the sequential write request (SEG_WRITE_NOT_BUSY), the host 102 can transmit a sequential write request with a small chunk of data to the memory system 110. It is unlikely that performance of the data processing system will be dropped or aggravated by the sequential write request.

Because there may be no expectation about a performance drop of the data processing system, the host 102 may transmit a sequential write request with a small chunk of data to the memory system 110.

Through the procedure described above, when the memory system 110 transmits to the host 102 an operational status regarding an operation corresponding to a sequential write request, the host 102 may adjust a data I/O request based on the operational status of the memory system 110. For example, the host 102 may change a size of data to be transmitted with the sequential write request, thereby avoiding deterioration of data input/output performance in the data processing system.

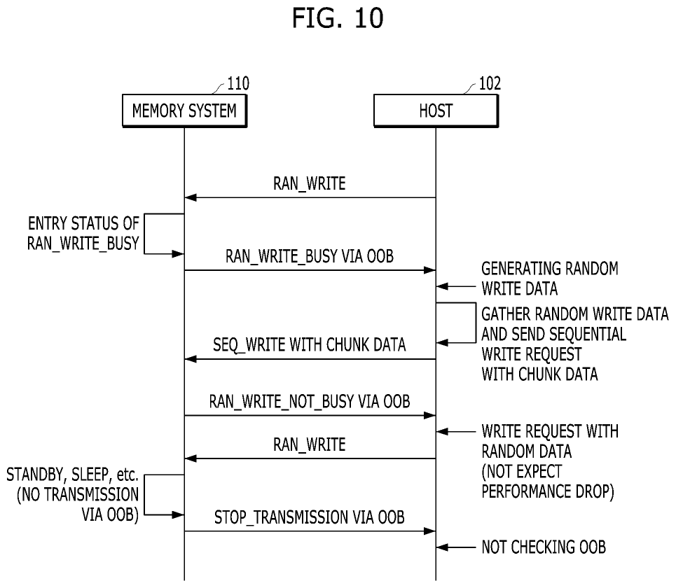

FIG. 10 shows a third operation of the data processing system according to an embodiment of the disclosure. Unlike FIG. 9 describing a procedure between the memory system 110 and the host 102 for performing operations corresponding to a sequential write request, FIG. 10 illustrates operations of the memory system 110 and the host 102 regarding a random write request.

Referring to FIG. 10, the host 102 may transmit a random write request to the memory system 110. The memory system 110 may store a piece of data transferred together with the random write request from the host 102. The memory system 110 may normally perform an operation corresponding to the random write request inputted from the host 102, and may receive another random write request while performing the operation. However, due to various reasons (e.g., limited input/output performance of the memory system 110, many sequential write commands from the host 102, and the like), the memory system 110 may become in a busy status (status entry of RAN_WRITE_BUSY) while performing operations corresponding to the random write requests which have previously inputted from the host 102.

Through the OOB communication way, the memory system 110 may inform the host 102 of an operational status of the memory system 110, i.e., the busy status in which the memory system 110 cannot immediately perform an operation corresponding to a random write request newly inputted from the host 102.

In the host 102, a random write request regarding another piece of data may occur. After the host 102 receives the operational status of the memory system 110 and recognizes that the memory system 110 is in the busy status in which the memory system 110 may not immediately perform an operation corresponding to a random write request, the host 102 may not transmit random write requests with other pieces of data but can gather or collect the random write requests in the buffer. The host 102 may change the random write requests gathered or collected in the buffer into a sequential write request with a small chunk of data before transferring the other pieces of data to the memory system 110. This process may improve a data input/output performance of the data processing system. Thereafter, the host 102 may transfer the changed sequential write request with a preset-size chunk of data to the memory system 110.

The memory system 110 may perform an operation corresponding to the sequential write request regarding the preset-size chunk of data transmitted from the host 102, so that a performance drop caused by plural random write requests may be restored (e.g., data I/O performance of the data processing system, lowered by random write requests, may be improved by the sequential write request). When determining that an operation corresponding to a following data input/output request inputted from the host 102 can be immediately performed, the memory system 110 may transmit a not busy status regarding the random write request (RAN_WRITE_NOT_BUSY) to the host 102 through the OOB communication way.

After the host 102 recognizes that the memory system 110 is not busy for performing an operation corresponding to a random write request, the host 102 does not have to hold random write requests in the buffer for changing the random write requests into a sequential write request. Because the memory system 110 is not busy for performing an operation corresponding to the random write command (RAN_WRITE_NOT_BUSY), it is determined that a performance drop or aggravation regarding data input/output between the memory system 110 and the host 102 in the data processing system may not be expected even if the host 102 transmits a random write request with a piece of data to the memory system 110.

Thereafter, the host 102 may transfer a random write request with a piece of data to the memory system 110. Herein, a size of data transferred along with the random write request can be smaller than that of the small chunk of data transmitted with the sequential write request.

Through the procedure described above, when the memory system 110 transmits an operational status regarding a random write request to the host 102, the host 102 may temporarily hold plural random write requests and change the plural random write requests into a sequential write request, thereby improving data input/output performance of the data processing system.

Furthermore, when it is determined or estimated that the memory system 110 could not transmit to the host 102 an operational status (such as a standby state, a sleep mode or etc.) through the OOB communication way, the memory system 110 may transfer status information (STOP_TRANSMISSION) to the host 102 through the OOB communication way. When recognizing that the memory system 110 does no longer transmit an operational status to the host 102 in the OOB communication way, the host may not check or monitor a packet received or delivered through the OOB communication way.

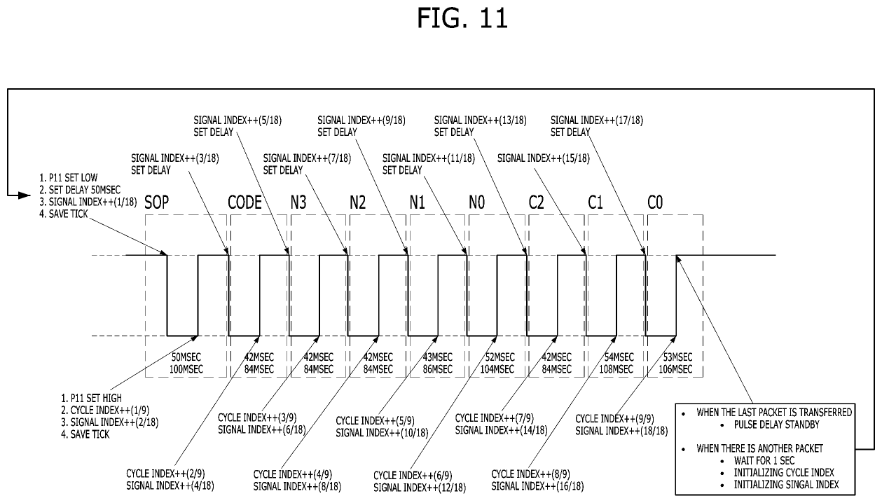

FIG. 11 describes a pulse used for a packet in an OOB communication way according to an embodiment of the disclosure.

Referring to FIG. 11, the memory system may transmit its operational status to the host by using a form of packet having a preset or protocol-defined structure/format through the OOB communication way. After power is applied, a line (path or channel) used for the OOB communication way can be maintained at a first level (e.g., a logical high level) indicating an inactive state. The memory system may change the first level of the line to a second level (e.g., a logical low level) indicating an active state in response to information to be sent to the host. The operational status to be transferred can be implemented with a pulse of a cycle including the active state and the inactive state. Referring to FIG. 5, the cycle of the pulse may be changed based on information such as the operational status to be transmitted to the host.

According to an embodiment, a packet transmitted in the OOB communication way may include a start variable (start of packet, SOP), a type of codes (Code), a status variable (N0 to N3) and an error checking variable (C0 to C2). Herein, the start variable SOP may indicate the beginning of a packet, which may have a cycle predetermined by the memory system and the host. For example, the start variable SOP may be implemented as a single cycle of the pulse having a 100 msec length (an active state of 50 msec and an inactive state of 50 msec). According to an embodiment, the start variable SOP may be implemented with plural cycles of the pulse. Further, the start variable (SOP) may have a unique or distinct length cycle(s) different from other parts of the packet. For example, when the start variable SOP of the packet is implemented with a cycle of 100 msec, another part (e.g., a code or another variable) of the packet cannot have a 100 msec cycle.

Although not shown, a transmitter for the OOB communication in the memory system may use a circuit, which is used for delaying a signal, to adjust a cycle of the pulse or a time length of active or inactive states in the pulse. In addition, the transmitter in the memory system may increase or count a signal index whenever a logical level of the pulse is changed, to check a length of the packet. For example, when the packet consists of nine cycles of the pulse, the signal index may be increased from 1 to 18. For another example, when the memory system counts a cycle of the pulse, a cycle index may be increased from 1 to 9.

The packet may include the start variable SOP followed by a code. As described above with reference to FIG. 7, the code may be defined by classifying data or information about operations performed by the memory system. Referring to FIGS. 8 to 10, the memory system may transmit an operational status, corresponding to various operations internally performed, to the host by using a preset code, so that the host may perform or adjust an operation regarding data input/output based on the operational status of the memory system.

The packet may include the code followed by a status variable (N0 to N3). In FIG. 11, the status variable may be implemented with four nibbles of data N0 to N3, that is, 4 cycles in the pulse, but may be changed according to an embodiment. For example, the fourth nibble N3 and the third nibble N2 may have a cycle of 84 msec (each having an active state of 42 msec), and the second nibble N1 may have a cycle of 86 msec (active state of 43 msec). The first nibble N0 may have a cycle of 104 msec (active state of 52 msec). According to an embodiment, a value corresponding to each cycle may vary, and each cycle may correspond to a nibble that can show 4-bit data or information. In this case, one cycle of the pulse may represent four-bit information and each cycle may have at least 16 different time lengths. For example, when the active state of each cycle is adjusted by 1 msec, one cycle may be adjusted by 2 msec.

The packet may include an error checking variable C0 to C2 following the status variables N0 to N3. According to an embodiment, the error checking variables C0 to C2 may include a parity or a cyclic redundancy check (CRC). In FIG. 11, three nibbles of data for a cyclic redundancy check (CRC), that is, three cycles of the pulse, may be assigned for the error checking variable C0 to C2. Referring to FIG. 11, the third nibble C2 may have a cycle of 84 msec (active state of 42 msec), the second nibble C1 may have a cycle of 108 msec (active state of 54 msec), and the first nibble C0 may have a cycle of 106 msec (active state of 53 msec).

Referring to FIG. 11, after delivering a single packet including nine cycles of the pulse, there may be a waiting time of 1 second for another packet. During the waiting time of 1 second, the transmitter of the memory system may initialize the signal index (or the cycle index) to prepare another packet. When there is no packet to be transferred in the OOB communication way, the line (path or channel) for OOB communication may remain in the inactive state. The inter-packet waiting time to clarify distinction between packets (waiting time between two neighboring packets) may be different based on an embodiment. In an embodiment, the waiting time may be longer than the maximum length of a single packet (e.g., the maximum length of nine cycles). According to an embodiment, when the waiting time is longer than at least two cycles of the maximum time in the packet, it is possible that the waiting time may be used to distinguish two neighboring packets from each other.

In FIG. 11, the packet having 9 nibbles (nine pieces of 4-bit data) is implemented with 9 cycles of the pulse. However, according to an embodiment, the number of nibbles included in the packet and data or information included in the packet can vary.

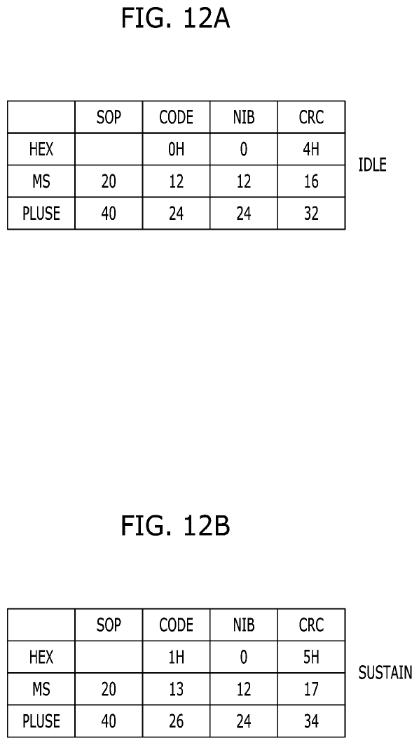

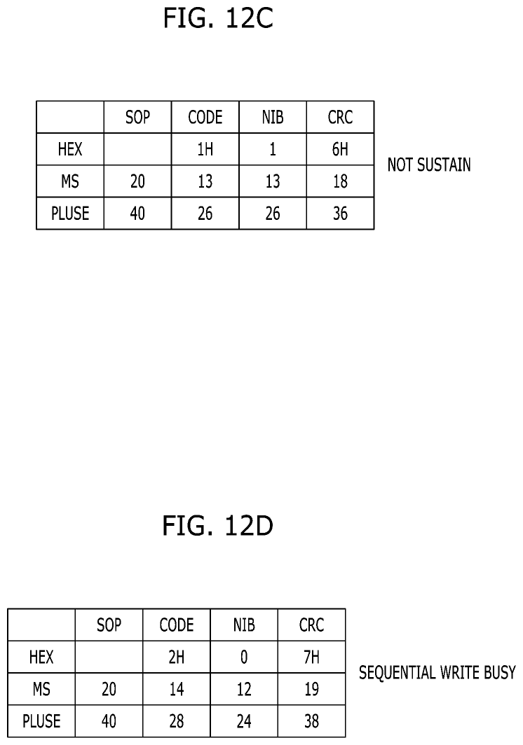

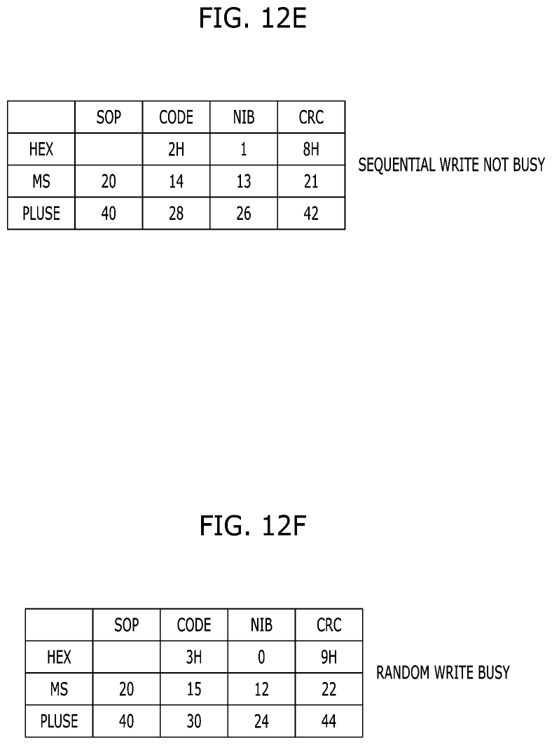

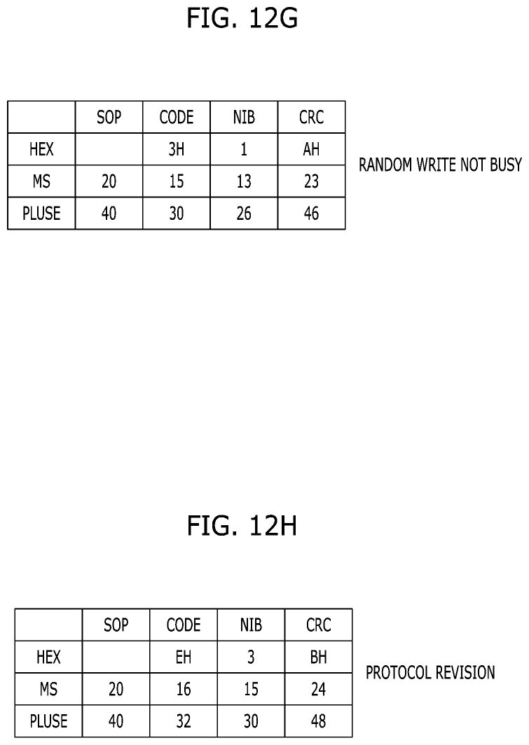

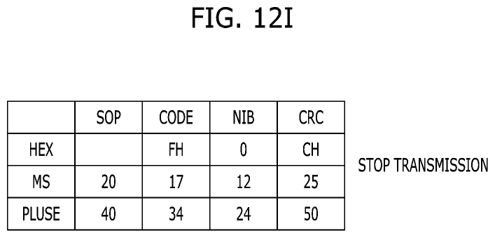

FIGS. 12A to 12I illustrate a packet configuration used in an OOB communication way according to an embodiment of the disclosure. By way of example but not limitation, FIGS. 12A to 12I illustrate various configurations of the packet transmitted in the OOB communication way. The packet may include information indicating an operational status of the memory system. The packet to be delivered may be implemented with various combinations according to an embodiment. As an example, the packet transmitted through the OOB communication way includes a start variable, a code, a status variable and an error checking variable.

Referring to FIG. 12A, a case in which the memory system delivers an idle status to the host will be described. For example, a pulse can include the start variable SOP, e.g., a cycle of 40 msec (active state of 20 msec). The pulse further includes a cycle corresponding to the hexa-code of ‘0H,’ e.g., a cycle of 24 msec (active state of 12 msec). The pulse can include a status variable (NIB of the hexa-code ‘0H’), e.g., a cycle of 24 msec (active state of 12 msec), following the code of ‘0H.’ The pulse may further include an error checking variable (CRC of the hexa-code ‘4H’), e.g., a cycle of 32 msec (active state of 16 msec) following the status variable.

Referring to FIG. 12B, the memory system may transfer its operational status (Sustain Status) to the host. In the sustain status, the memory system may not immediately perform an operation corresponding to a data input/output request inputted from the host. For example, a pulse may include a first cycle of 40 msec (active state of 20 msec) corresponding to the start variable SOP like that shown in FIG. 12A. The first cycle may be followed by a cycle corresponding to the hexa-code ‘1H,’ e.g., a cycle of 26 msec (active state of 13 msec). The pulse further includes a status variable (NIB of the hexa-code ‘0H’), e.g., a cycle of 24 msec (active state of 12 msec). The pulse may include the error checking variable corresponding to CRC of the hexa-code ‘5H’, e.g., a cycle of 34 msec (active state of 17 msec).

Referring to FIG. 12C, the memory system may transfer its operational status (NOT Sustain Status) to the host. In the NOT sustain status, the memory system can immediately perform an operation corresponding to a data input/output request inputted from the host. For example, a pulse used for transferring the NOT sustain status can include the start variable SOP, e.g., a cycle of 40 msec (active state of 20 msec), like that shown in FIGS. 12A and 12B. The pulse further includes a cycle corresponding to the hexa-code ‘1H,’ having a time length of 26 msec (active state of 13 msec). The pulse may include a status variable of NIB of the hexa-code ‘1H,’ which is implemented with a cycle of 26 msec (active state of 13 msec). The pulse may include an error checking variable of CRC of the hexa-code ‘6H,’ which is represented through a cycle of 36 msec (active state of 18 msec).

Referring to FIG. 12D, the memory system may transmit it to a host that an operational status regarding a sequential write operation is busy (Sequential Write Busy). In the operational status (Sequential Write Busy), the memory system may not immediately perform an operation corresponding to a sequential write request newly inputted from the host. For example, a pulse may include a first cycle corresponding to the start variable SOP of the packet, which has a time length of 40 msec (active state of 20 msec) similar to those described with reference to FIGS. 12A to 12C. The pulse may include a hexa-code ‘2H’ represented by a cycle of 28 msec (active state of 14 msec). The pulse may include a status variable of NIB of the hexa-code ‘0H’ corresponding to a cycle of 24 msec (active state of 12 msec). The pulse may further include an error checking variable of CRC of the hexa-code ‘7H’ corresponding to a cycle of 38 msec (active state of 19 msec).

Referring to FIG. 12E, a table may describe a configuration of packet when the memory system transmits it to the host that an operational status regarding a sequential write operation is not busy (Sequential Write Not Busy). In this operational status (Sequential Write Not Busy), the memory system can be ready to immediately perform an operation corresponding to a sequential write request newly inputted from the host. For example, a pulse may include the start variable SOP implemented with a cycle of 40 msec (active state of 20 msec), similar to those described with reference to FIGS. 12A to 12D. The pulse may include a hexa-code ‘2H’ represented by a cycle of 28 msec (active state of 14 msec) following the start variable. The pulse may further include a status variable of NIB of the hexa-code ‘1H’ have a cycle of 26 msec (active state of 13 msec). The pulse may include an error checking variable of CRC of the hexa-code ‘8H’ which may be implemented with a cycle of 42 msec (active state of 21 msec).

Referring to FIG. 12F, a table showing a configuration of packet may be used when the memory system transmits it to the host that an operational status regarding a random write operation is busy (Random Write Busy). In the operational status (Random Write Busy), the memory system may not immediately perform an operation corresponding to a random write request newly inputted from the host. For example, a pulse corresponding to the packet may include a cycle of 40 msec (active state of 20 msec) corresponding to a start variable SOP similar to those shown in FIGS. 12A to 12E. The pulse may further include a hexa-code ‘3H’ implemented with a cycle of 30 msec (active state of 15 msec) following the start variable SOP. The pulse may include a status variable of NIB of the hexa-code ‘0H’ represented by a cycle of 24 msec (active state of 12 msec). The pulse may further include an error checking variable of CRC of the hexa-code ‘9H,’ which may have a time length of 44 msec (active state of 22 msec).

Referring to FIG. 12G, the memory system can transmit a packet to the host. The packet shows that an operational status regarding a random write operation is not busy (Random Write Not Busy). In this operational status (Random Write Not Busy), the memory system can be ready to perform an operation corresponding to a random write request newly inputted from the host. For example, a pulse corresponding to the packet may include a start variable SOP implemented with a cycle of 40 msec (active state of 20 msec), similar to those described in FIGS. 12A to 12F. The pulse can further include a hexa-code ‘3H’ represented by a cycle of 30 msec (active state of 15 msec) following the start variable. The pulse may include a status variable of NIB of the hexa-code ‘1H,’ which may have a time length of 26 msec (active state of 13 msec). The pulse may include an error checking variable of CRC of the hexa-code ‘AH,’ which may be implemented with a cycle of 46 msec (active state of 23 msec).

Referring to FIG. 12H, a table showing a configuration of packet may be used when the memory system delivers a protocol revision to a host. Through this packet, the memory system may notify the host how many types of data or information regarding an operation (e.g., operational status) the memory system can generate and transfer. For example, a pulse corresponding to the packet may include a start variable SOP implemented with a cycle of 40 msec (active state of 20 msec), similar to those shown in FIGS. 12A to 12G. The pulse may further include a hexa-code ‘EH’ represented by a cycle of 32 msec (active state of 16 msec) following the start variable. The pulse may include a status variable of NIB of the hexa-code ‘3H,’ which may have a time length of 30 msec (active state of 15 msec). The pulse may include an error checking variable of CRC of the hexa-code ‘BH’ implemented with a cycle of 48 msec (active state of 24 msec).

Referring to FIG. 12I, a table showing a configuration of packet may be used when the memory system delivers a stop transmission to the host. Using this packet, the memory system may inform the host of an operation status in which the memory system no longer transfers data or information through in the OOB communication way. For example, a pulse corresponding to the packet may include a start variable SOP represented by a cycle of 40 msec (active state of 20 msec), similar to those described with reference to FIGS. 12A to 12H. The pulse may further include a hexa-code ‘FH,’ which may be represented by a cycle of 34 msec (active state of 17 msec) following the start variable SOP. The pulse may include a status variable of NIB of the hexa-code ‘0H’ having a time length of 24 msec (active state of 12 msec). The pulse may include an error checking variable of CRC of the hexa-code ‘CH,’ which may be implemented with a cycle of 50 msec (active state of 25 msec).

Referring to FIGS. 12A to 12I, a packet transmitted and received through the OOB communication way may be configured depending on a type (e.g., a code), a state variable or etc. of operational status transmitted from the memory system to the host. According to an embodiment, a packet transmitted and received through the OOB communication way may be configured differently based on what type of operational status is delivered or how many operational statuses are delivered at once.

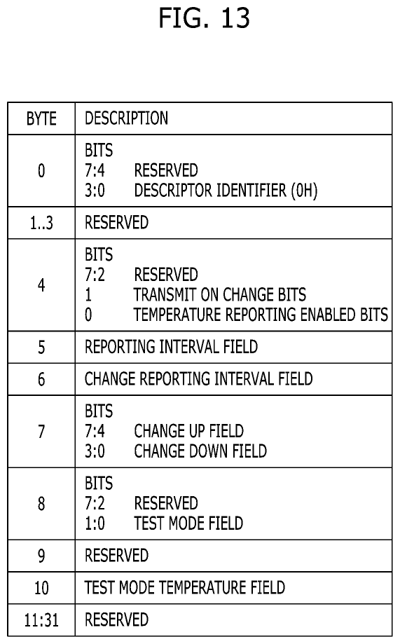

FIG. 13 shows a first example of specifications used in an OOB communication way according to an embodiment of the disclosure.

Referring to FIG. 13, the memory system may transmit temperature information to the host through the OOB communication way. For example, a packet carrying the temperature information may have a length of up to 32 bytes. Each byte of 11 bytes constituting the packet may be matched with pre-defined information described with reference to FIG. 13.

Referring to FIGS. 11 through 12I, the memory system may transmit a packet including nine nibbles to the host through the OOB communication way. Nine nibbles (each corresponding to 4-bit data) can contain data represented by 36 bits. According to an embodiment, if nine nibbles (36 bits) are reconstructed in a unit of bytes (each matched with 8 bits), one packet may include 4 bytes of data. For example, some information or data contained in the first byte (0 byte), the fifth byte (4 byte), the sixth byte (5 byte), the seventh byte (6 byte), the eighth byte (7 byte), the ninth of bytes (8 byte) and the 11th byte (10 byte) may be selected, reconstructed and inserted into the packet including 4 bytes of data, which is used in the OOB communication way.

When the host or an external device checks or monitors the temperature information of the memory system, operational reliability or safety of the memory system can be enhanced. The temperature information may be used for a test. For example, a packet used in the OOB communication way may include information or data regarding a test mode field and a test mode temperature field included in the ninth byte (8 byte) and the tenth byte (10 byte) shown in FIG. 13.

According to an embodiment, the test mode of two bits (1:0 Bits) in the ninth byte (8 byte) can be set in more detail. For example, a first mode (0,0) of the four modes determined by the two bits (1:0 Bits) may indicate the end of the test mode. A second mode (0,1) of the four modes can test whether a temperature value can be outputted by increasing the temperature by a preset value (for example, 1 degree). A third mode (1,0) of the four modes can test whether the temperature value can be outputted by reducing the temperature by a preset value (for example, 1 degree). The temperature value may be outputted through the test mode temperature field. For example, the test mode temperature field (TEST MODE TEMPERATURE FIELD) may include 1 byte (8 bits), so that a range of temperature can show 256 different levels. According to an embodiment, that field using 1 byte may be represented from minus 128 degrees below zero to 128 degrees above zero. A fourth mode (1,1) of the four modes can test whether a preset fixed value can be outputted.

When the test mode ends, an internal temperature of the memory system may be transmitted to the host through the OOB communication way, through the test mode temperature field in the first mode (0,0). The host may change, adjust or reconfigure data input/output operations based on the internal temperature of the memory system. In addition, when the host determines that it is difficult for the memory system to perform an operation normally, the host may schedule a data input/output operation so that the internal temperature of the memory system can be maintained within a preset range in which it may be guaranteed to perform an operation normally. A host's scheduling can bring about lowering or increasing the internal temperature of the memory system.

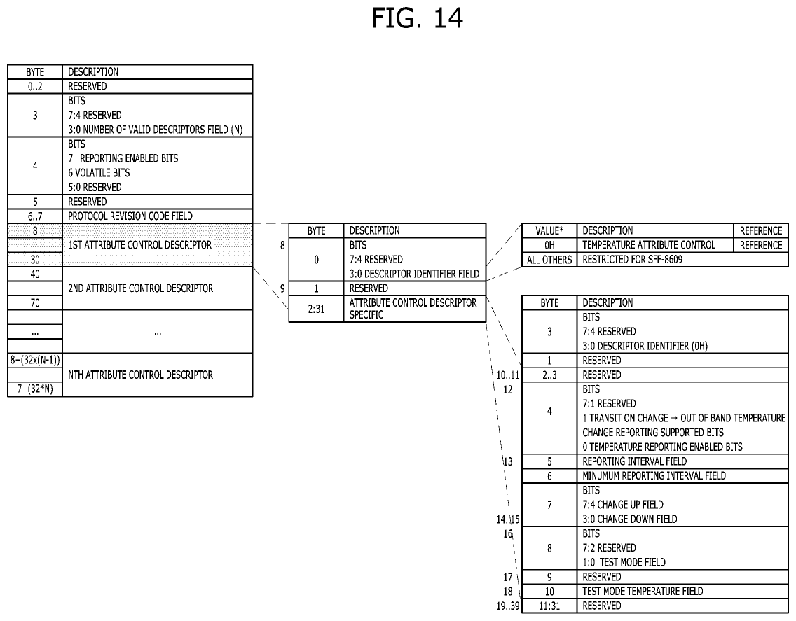

FIG. 14 shows a second example of specifications used in an OOB communication way according to an embodiment of the disclosure.

Referring to FIG. 14, when the memory system and the host transmits/receives an operational status of the memory system through the OOB communication way, how to set a log is described. For example, a volatile bit defined at the seventh bit (6 Bit) of the 5th byte (4 Byte) may indicate whether contents of the log page for managing and controlling the OOB communication can persist even when the memory system is reset. If the volatile bit is set to ‘1’, the contents of the log page may be defined as described in FIG. 14. Contents of first control descriptors (Bytes 8 to 30) in the log page may be used as a protocol for exchanging information or data regarding the internal temperature of the memory system as described in FIG. 13.

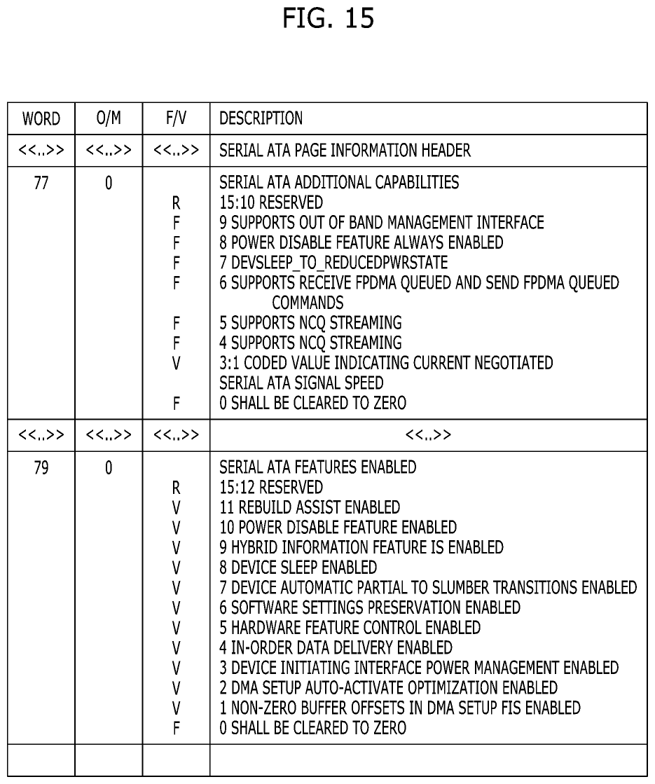

FIG. 15 illustrates a third example of specifications used in an OOB communication way according to an embodiment of the disclosure. Specifically, FIG. 15 illustrates device identification used in a Serial ATA (SATA) which is a computer bus interface connecting the host and the memory system.

Referring to FIG. 15, the device identification for SATA may include an area for checking whether the OOB communication is supported. Specifically, referring to the 78th word (each word being 16-bit data) information (77 Word), whether the OOB communication is supported (Supports Out Of Band Management Interface) is set at the 10th bit (Bit 9) in an area where additional capabilities regarding Serial ATA is recorded. The memory system and the host may use an indicator of whether the OOB communication is supported in the device identification of the Serial ATA (SATA), which may be exchanged through the in-band communication way (e.g., a data bus).

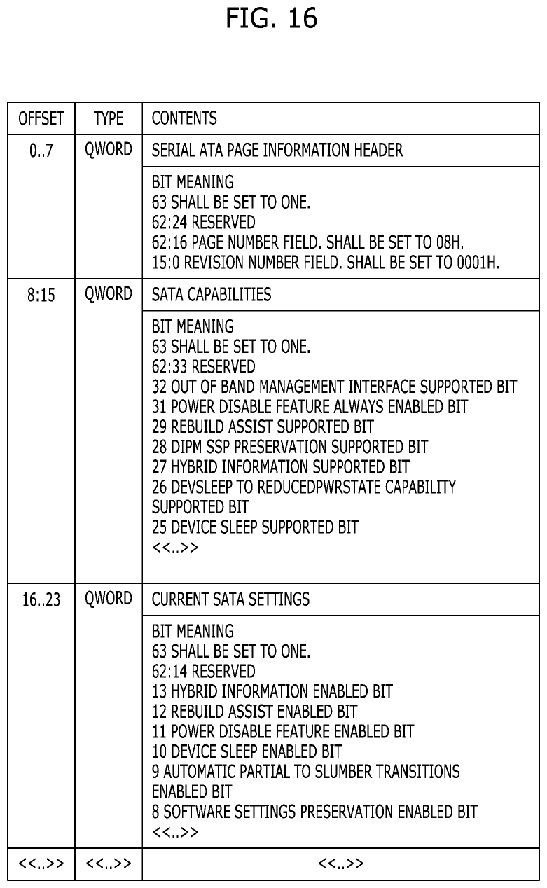

FIG. 16 describes a fourth example of specifications used in an OOB communication way according to an embodiment of the disclosure. Specifically, FIG. 16 illustrates a log page used in a Serial ATA (SATA) which is a computer bus interface connecting the host and the memory system.

Referring to FIG. 16, the log page for SATA may include an area for checking whether the OOB communication is supported. Specifically, in 64-bit data (Qword) of SATA capabilities including SATA performance, whether the OOB communication is supported (Out Of Band Interface Supported Bit) is set at the 33^{rd} bit (Bit 32). The memory system and the host may use the log page including an indicator of whether the OOB communication is supported in the device identification of the Serial ATA (SATA), which may be exchanged through the in-band communication way (e.g., the data bus).

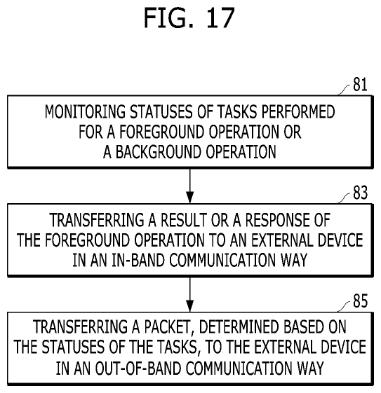

FIG. 17 shows a method for operating a memory system according to an embodiment of the disclosure.

Referring to FIG. 17, the method may include monitoring statuses of tasks performed for a foreground operation or a background operation (81), transferring a result or a response of the foreground operation to an external device in an in-band communication way (83), and transferring a packet, determined based on the statuses of the tasks, to the external device in an out-of-band communication way (85). Here, the external device may include the host described with reference to FIGS. 1 to 10.

A foreground operation may include a task or process internally carried out by the memory system, in response to a request inputted from an external device. A background operation may include a task or process independently performed in the memory system regardless of a request inputted from the external device. For example, the foreground operation may include data input/output operations based on a write request, a read request and the like. The background operation may include operations such as garbage collection and wear leveling. According to an embodiment, the memory system may perform a background operation only when the external device allows the memory system to perform the background operation. In addition, when it is determined that a background operation is necessary, the memory system may transmit a request or an inquiry regarding the background operation to the external device.

The memory system may monitor a task execution status according to a foreground operation or a background operation, and determine whether the memory system is capable of immediately performing another operation. After monitoring the task execution status, the memory system may configure a packet transmitted through the OOB communication way according to a monitoring result. In an embodiment, the packet may include a first type item, including a parameter regarding an idle status, a data input/output processing status and a status showing a sequential or random write operation in the memory system, and a second type item including a variable corresponding to the parameter. According to an embodiment, the packet may include one or more codes and one or more variables corresponding to the one or more codes.

According to an embodiment, a method for configuring a packet structure or a packet format may be different. Referring to FIGS. 7 to 13, a packet transmitted through the OOB communication way may include data or information regarding an idle status, an input/output processing status, a sequential write status, and a random write status of a memory system, as well as internal temperature of the memory system. Also, when testing the memory system, the packet transmitted through the OOB communication way may be used for outputting a test result.

In an embodiment of the disclosure, a data processing system, a method for operating the data processing system and a method of controlling an the operation in the data processing system can provide a memory system which is capable of transferring an operational status to a host in an out-of-band (OOB) communication way. The embodiment can extend a type or a range of data or information which the memory system transfers to the host, so that an operational efficiency of the data processing system or the memory system could be improved.

In an embodiment of the disclosure, overhead caused by transmission of an operational status of a memory system could be avoided or reduced while plural pieces of data are inputted to or outputted from the memory system. Data input/output performance of the memory system (e.g., I/O bandwidth or I/O throughput) may not be affected or deteriorated, so that performance of a data processing system including the memory system may be improved.

While the present teachings have been illustrated and described with respect to the specific embodiments, it will be apparent to those skilled in the art in light of the present disclosure that various changes and modifications may be made without departing from the spirit and scope of the disclosure as defined in the following claims.

What is claimed is:

1. A data processing system comprising a memory system configured to:
transfer to or receive from a host, a piece of data in an in-band communication way, and
transfer a packet to the host in an out-of-band communication way,
wherein the packet includes:
a first type item including a parameter regarding an idle status, a data input/output processing status and a status showing a sequential or random write operation in the memory system, and
a second type item including a variable corresponding to the parameter.

2. The data processing system according to claim 1, wherein the data input/output processing status indicates whether an input/output throughput of the memory system is slower than a first reference based on a task handled in the memory system.

3. The data processing system according to claim 2, wherein the task includes a process performed for a read operation, a background operation, a data migration operation or a data copy operation.

4. The data processing system according to claim 1, wherein the status showing the sequential write operation is determined according to a result of comparing a second reference with an amount of remaining data to be stored in the memory system in response to a sequential write request inputted from the host.

5. The data processing system according to claim 1, wherein the status showing the random write operation is determined according to a result of comparing a third reference with an amount of remaining data to be stored in the memory system in response to a random write request inputted from the host.

6. The data processing system according to claim 1, wherein the memory system is configured to transfer the packet to the host regardless of the host's request.

7. The data processing system according to claim 1,
wherein the first type item further includes another parameter regarding an internal temperature of the memory system, and
wherein the second type item further includes a variable corresponding to the another parameter.

8. The data processing system according to claim 1, wherein the first type item further includes one of identification information of the memory system and log information regarding the plural parameters and the plural variables transferred through the out-of-band communication way.

9. The data processing system according to claim 1, wherein the packet further includes:
a first variable indicating a beginning of the packet, and
a second variable used for checking a data error included in the packet.

10. The data processing system according to claim 9,
wherein the packet includes a pulse having a preset number of cycles,
wherein each cycle includes an active state and an inactive state which have equal time, and
wherein a length of each cycle is determined based on a length of each active state.

11. The data processing system according to claim 10, wherein the first type item, the second type item, the first variable and the second variable independently include at least one nibble showing 4-bit data in a single cycle of the pulse.

12. The data processing system according to claim 11, wherein the packet includes the first variable and the first type item independently implemented with a single cycle of the pulse, the second type item implemented with four cycles of the pulse, and the second variable implemented with three cycles of the pulse.

13. The data processing system according to claim 10, wherein the memory system is further configured to maintain a communication line for the out-of-band communication way is in an inactive state for more than twice as long as the cycle after completing transmission of the packet.

14. A memory system comprising:
a memory device including plural non-volatile memory cells; and
a controller configured to:
perform, in response to a request inputted from a host through an in-band communication way, an operation for storing a piece of data in the memory device or outputting the piece of data stored in the memory device, and
transfer, based on a status of the operation, a packet to the host through an out-of-band communication way,
wherein the packet includes:
a first type item including a parameter regarding an idle status, a data input/output processing status, a status showing a sequential or random write operation and an internal temperature in the memory system, and
a second type item including a variable corresponding to the parameter.

15. The memory system according to claim 14, wherein the data input/output processing status indicates whether an input/output throughput of the memory system is slower than a first reference based on a task handled in the memory system.

16. The memory system according to claim 14,
wherein the status showing the sequential write operation is determined according to a result of comparing a second reference with an amount of remaining data to be stored in the memory system in response to a sequential write request inputted from the host, and
wherein the status showing the random write operation is determined according to a result of comparing a third reference with an amount of remaining data to be stored in the memory system in response to a random write request inputted from the host.

17. The memory system according to claim 14, wherein the packet further includes:
a first variable indicating a beginning of the packet, and
a second variable used for checking a data error included in the packet.

18. The memory system according to claim 17, wherein the packet includes the first variable and the first type item independently implemented with a single cycle of the pulse, the second type item implemented with four cycles of the pulse, and the second variable implemented with three cycles of the pulse.

19. The memory system according to claim 17, wherein the memory system is further configured to maintain a communication line for the out-of-band communication way is in an inactive state for more than twice as long as a cycle of the packet including a pulse of a preset number of cycles after completing transmission of the packet.

20. A method for operating a memory system, comprising:
monitoring statuses of tasks performed for a foreground operation or a background operation;
transferring a result or a response of the foreground operation to an external device through an in-band communication way; and
transferring a packet, which is determined based on the statuses of the tasks, to the external device through an out-of-band communication way,
wherein the packet includes:
a first type item including a parameter regarding an idle status, a data input/output processing status and a status showing a sequential or random write operation in the memory system, and
a second type item including a variable corresponding to the parameter.
